(19) United States
(12) Patent Application Publication
(10) Pub. No.: US 2006/0287422 A1
(43) Pub. Date: Dec. 21, 2006

(54) Thermoplastic polycarbonate compositions with improved mechanical properties, articles made therefrom and method of manufacture

(75) Inventors: Andries Adriaan Volkers, Wouw (NL); Robert Walter Venderbosch, Bergen op Zoom (NL); Wilhelmus Johannes Daniel Steendam, Bergen op Zoom (NL); Bernardus Antonius Gerardus Schrauwen, Tilburg (NL)

Correspondence Address: GEAM - CYCOLOY, IP LEGAL, ONE PLASTICS AVENUE, PITTSFIELD, MA, 01201-3697, US

(73) Assignee: General Electric Company, Schenectady, NY (US)

(21) Appl. No.: 11/154,501

(22) Filed: Jun. 16, 2005

(51) Int. Cl. C08K 3/32

(52) U.S. Cl. 524/417; 524/611

(57) ABSTRACT

A thermoplastic composition comprising a polycarbonate resin, a mineral filler and an acid or an acid salt, and optionally an aromatic vinyl copolymer and/ or an impact modifier, has been found to exhibit improved characteristics and less degradation than filled thermoplastic compositions without the acid or acid salt. In some embodiments the composition exhibits improved impact and ductility, as well as molecular weight retention. An article may be formed by molding, extruding, shaping or forming such a composition to form the article.

### BACKGROUND OF THE INVENTION

This invention is directed to thermoplastic compositions comprising an aromatic polycarbonate, and in particular filled thermoplastic polycarbonate compositions having improved mechanical properties.

Polycarbonates are useful in the manufacture of articles and components for a wide range of applications, from automotive parts to electronic appliances. Because of their broad use, particularly in metal replacement applications, such as in automotive applications, there is a need for increased stiffness, reduced coefficient of thermal expansion while maintaining excellent ductility and flow.

One known method of increasing stiffness in polycarbonates is with the addition of mineral fillers, such as talc and mica. A problem with mineral filled polycarbonate compositions and blends of polycarbonate compositions is that mineral filled, specifically talc and/or mica filled, polycarbonate or polycarbonate blends degrade upon processing. As used herein, “degrade” and “degradation” of polycarbonates or polycarbonate blends are known to one skilled in the art and generally refer to a reduction in molecular weight and/or a change for the worse in mechanical or physical properties.

There remains a need to reduce or control the amount of degradation encountered with filled polymeric materials, and to provide filled materials with improved mechanical properties similar to unfilled polycarbonates and polycarbonate blends.

### SUMMARY OF THE INVENTION

A thermoplastic composition comprises a polycarbonate resin, a mineral filler, and an acid or an acid salt, wherein the acid or acid salt is present in the composition in a weight ratio of acid to filler of at least 0.0035:1. The thermoplastic composition of the invention has improved mechanical properties.

In another embodiment, a thermoplastic composition comprises a polycarbonate resin, an impact modifier, a mineral filler, and an acid or an acid salt, and optionally an aromatic vinyl copolymer, wherein the acid or acid salt is present in the composition in a weight ratio of acid to filler of at least 0.0035:1. The composition has improved mechanical properties.

In an alternative embodiment, a thermoplastic composition comprises a polycarbonate resin, an impact modifier, a mineral filler, and an acid or an acid salt, and an aromatic vinyl copolymer, wherein the acid or acid salt is present in the composition in a weight ratio of acid to filler of at least 0.0035:1.

An article may be formed by molding, extruding, shaping or forming such a composition to form the article.

One method for forming an article comprises molding, extruding, shaping or forming the composition to form the article.

The above-described and other features are exemplified by the following detailed description.

### DETAILED DESCRIPTION OF THE INVENTION

A thermoplastic composition comprising a polycarbonate resin, a mineral filler and an acid or an acid salt, and optionally an aromatic vinyl copolymer and/or an impact modifier, wherein the acid or acid salt is present in the composition in a weight ratio of acid to filler of at least 0.0035:1, has been found to exhibit improved mechanical properties and other characteristics and less degradation than filled thermoplastic compositions without the acid or acid salt. In some embodiments the composition exhibits improved impact and ductility, as well as molecular weight retention. As used herein, “molecular weight retention” means that the molecular weight of the polycarbonate measured after some type of processing is similar or not significantly different from the molecular weight of the polycarbonate before the processing. Processing includes, for example, compounding, molding, extruding, and other types of processing known to one skilled in the art.

It is known in the art to add acids or acid salts in very small quantities to polycarbonates and polycarbonate blends for the purpose of quenching, inactivating or deactivating undesirable components and for stabilizing the polycarbonate or polycarbonate blends. The addition of the acid often deactivates trans-esterification catalysts, polycarbonate synthesis or condensation catalysts. It is also known to use a composition comprising a combination of a phosphorous containing acid and an ester of a phosphorous containing acid to deactivate or inactivate undesirable ingredients. See, for example, U.S. Pat. No. 5,608,027 to Crosby et al., incorporated herein by reference. The acids, acid salts and esters of acids are used in very small levels to quench or inactivate, but when used in greater levels it is known that there is polycarbonate degradation.

As used herein, the terms “polycarbonate” and “polycarbonate resin” mean compositions having repeating structural carbonate units of the formula (1): 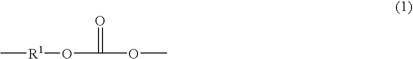
in which at least about 60 percent of the total number of R¹ groups are aromatic organic radicals and the balance thereof are aliphatic, alicyclic, or aromatic radicals. In one embodiment, each R¹ is an aromatic organic radical, for example a radical of the formula (2):
-A¹-Y¹-A²- (2)
wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3)
HO-A¹-Y¹-A²-OH (3)
wherein Y¹, A¹ and A² are as described above. Also included are bisphenol compounds of general formula (4): 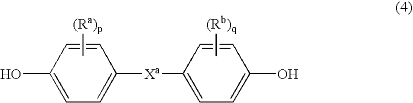
wherein R^{a} and R^{b} each represent a halogen atom or a monovalent hydrocarbon group and may be the same or different; p and q are each independently integers of 0 to 4; and X^{a} represents one of the groups of formula (5): 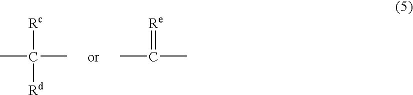
wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy compounds.

Specific examples of the types of bisphenol compounds that may be represented by formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, and 1,1-bis(4-hydroxy-t-butylphenyl) propane. Combinations comprising at least one of the foregoing dihydroxy compounds may also be used.

Branched polycarbonates are also useful, as well as blends of a linear polycarbonate and a branched polycarbonate. The branched polycarbonates may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05 wt. % to about 2.0 wt. %. All types of polycarbonate end groups are contemplated as being useful in the polycarbonate composition, provided that such end groups do not significantly affect desired properties of the thermoplastic compositions.

“Polycarbonates” and “polycarbonate resins” as used herein further includes blends of polycarbonates with other copolymers comprising carbonate chain units. A specific suitable copolymer is a polyester carbonate, also known as a copolyester-polycarbonate. Such copolymers further contain, in addition to recurring carbonate chain units of the formula (1), repeating units of formula (6) 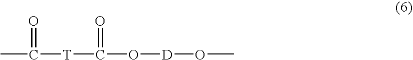
wherein D is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to about 6 carbon atoms, specifically 2, 3, or 4 carbon atoms; and T is a divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical.

In one embodiment, D is a C₂₋₆ alkylene radical. In another embodiment, D is derived from an aromatic dihydroxy compound of formula (7): 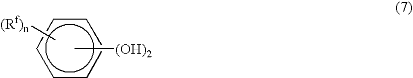
wherein each R^{f} is independently a halogen atom, a C₁₋₁₀ hydrocarbon group, or a C₁₋₁₀ halogen substituted hydrocarbon group, and n is 0 to 4. The halogen is usually bromine. Examples of compounds that may be represented by the formula (7) include resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like; or combinations comprising at least one of the foregoing compounds.

Examples of aromatic dicarboxylic acids that may be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof. A specific dicarboxylic acid comprises a mixture of isophthalic acid and terephthalic acid wherein the weight ratio of terephthalic acid to isophthalic acid is about 10:1 to about 0.2:9.8. In another specific embodiment, D is a C₂₋₆ alkylene radical and T is p-phenylene, m-phenylene, naphthalene, a divalent cycloaliphatic radical, or a mixture thereof. This class of polyester includes the poly(alkylene terephthalates).

In one specific embodiment, the polycarbonate is a linear homopolymer derived from bisphenol A, in which each of A¹ and A² is p-phenylene and Y¹ is isopropylidene.

Suitable polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformate of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used.

Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈₈ aryloxy group. Suitable phase transfer catalysts include, for example, [CH₃(CH₂)₃]₄NX, [CH₃(CH₂)₃]₄PX, [CH₃(CH₂)₅]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈₈ aryloxy group. An effective amount of a phase transfer catalyst may be about 0.1 to about 10 wt. % based on the weight of bisphenol in the phosgenation mixture. In another embodiment an effective amount of phase transfer catalyst may be about 0.5 to about 2 wt. % based on the weight of bisphenol in the phosgenation mixture.

Alternatively, melt processes may be used to make the polycarbonates. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue.

The polycarbonate resins may also be prepared by interfacial polymerization. Rather than utilizing the dicarboxylic acid per se, it is possible, and sometimes even preferred, to employ the reactive derivatives of the acid, such as the corresponding acid halides, in particular the acid dichlorides and the acid dibromides. Thus, for example, instead of using isophthalic acid, terephthalic acid, or mixtures thereof, it is possible to employ isophthaloyl dichloride, terephthaloyl dichloride, and mixtures thereof.

In addition to the polycarbonates described above, it is also possible to use combinations of the polycarbonate with other thermoplastic polymers, for example combinations of polycarbonates and/or polycarbonate copolymers with polyesters. As used herein, a “combination” is inclusive of all mixtures, blends, alloys, and the like. Suitable polyesters comprise repeating units of formula (6), and may be, for example, poly(alkylene dicarboxylates), liquid crystalline polyesters, and polyester copolymers. It is also possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

In one embodiment, poly(alkylene terephthalates) are used. Specific examples of suitable poly(alkylene terephthalates) are poly(ethylene terephthalate) (PET), poly(1,4-butylene terephthalate) (PBT), poly(ethylene naphthanoate) (PEN), poly(butylene naphthanoate), (PBN), (polypropylene terephthalate) (PPT), polycyclohexanedimethanol terephthalate (PCT), and combinations comprising at least one of the foregoing polyesters. Also contemplated are the above polyesters with a minor amount, e.g., from about 0.5 to about 10 percent by weight, of units derived from an aliphatic diacid and/or an aliphatic polyol to make copolyesters.

Blends and/or mixtures of more than one polycarbonate may also be used. For example, a high flow and a low flow polycarbonate may be blended together.

The thermoplastic composition optionally further includes one or more impact modifier compositions to increase the impact resistance of the thermoplastic composition. These impact modifiers may include an elastomer-modified graft copolymer comprising (i) an elastomeric (i.e., rubbery) polymer substrate having a Tg less than about 10° C., more specifically less than about −10° C., or more specifically about −40° C. to −80° C., and (ii) a rigid polymeric superstrate grafted to the elastomeric polymer substrate. As is known, elastomer-modified graft copolymers may be prepared by first providing the elastomeric polymer, then polymerizing the constituent monomer(s) of the rigid phase in the presence of the elastomer to obtain the graft copolymer. The grafts may be attached as graft branches or as shells to an elastomer core. The shell may merely physically encapsulate the core, or the shell may be partially or essentially completely grafted to the core.

Suitable materials for use as the elastomer phase include, for example, conjugated diene rubbers; copolymers of a conjugated diene with less than about 50 wt. % of a copolymerizable monomer; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers.

Suitable conjugated diene monomers for preparing the elastomer phase are of formula (8): 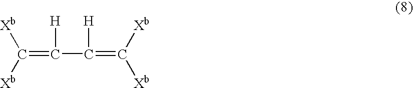
wherein each X^{b} is independently hydrogen, C₁-C₅ alkyl, or the like. Examples of conjugated diene monomers that may be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as mixtures comprising at least one of the foregoing conjugated diene monomers. Specific conjugated diene homopolymers include polybutadiene and polyisoprene.

Copolymers of a conjugated diene rubber may also be used, for example those produced by aqueous radical emulsion polymerization of a conjugated diene and one or more monomers copolymerizable therewith. Monomers that are suitable for copolymerization with the conjugated diene include monovinylaromatic monomers containing condensed aromatic ring structures, such as vinyl naphthalene, vinyl anthracene and the like, or monomers of formula (9): 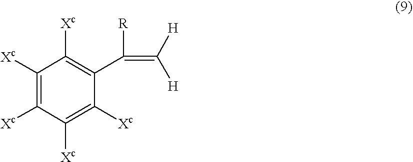
wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkaryl, C₁-C₁₂ alkoxy, C₃-C₁₂ cycloalkoxy, C₆-C₁₂ aryloxy, chloro, bromo, or hydroxy, and R is hydrogen, C₁-C₅ alkyl, bromo, or chloro. Examples of suitable monovinylaromatic monomers that may be used include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing compounds. Styrene and/or alpha-methylstyrene may be used as monomers copolymerizable with the conjugated diene monomer.

Other monomers that may be copolymerized with the conjugated diene are monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic formula (10): 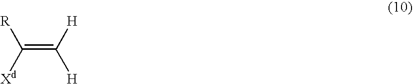
wherein R is hydrogen, C₁-C₅ alkyl, bromo, or chloro, and X^{d} is cyano, C₁-C₁₂ alkoxycarbonyl, C₁-C₁₂ aryloxycarbonyl, hydroxy carbonyl, or the like. Examples of monomers of formula (10) include acrylonitrile, ethacrylonitrile, methacrylonitrile, alpha-chloroacrylonitrile, beta-chloroacrylonitrile, alpha-bromoacrylonitrile, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and combinations comprising at least one of the foregoing monomers. Monomers such as n-butyl acrylate, ethyl acrylate, and 2-ethylhexyl acrylate are commonly used as monomers copolymerizable with the conjugated diene monomer. Mixtures of the foregoing monovinyl monomers and monovinylaromatic monomers may also be used.

Suitable (meth)acrylate monomers suitable for use as the elastomeric phase may be cross-linked, particulate emulsion homopolymers or copolymers of C₁₋₈ alkyl (meth)acrylates, in particular C₄₋₆ alkyl acrylates, for example n-butyl acrylate, t-butyl acrylate, n-propyl acrylate, isopropyl acrylate, 2-ethylhexyl acrylate, and the like, and combinations comprising at least one of the foregoing monomers. The C₁₋₈ alkyl (meth)acrylate monomers may optionally be polymerized in admixture with up to 15 wt. % of comonomers of formulas (8), (9), or (10). Exemplary comonomers include but are not limited to butadiene, isoprene, styrene, methyl methacrylate, phenyl methacrylate, penethylmethacrylate, N-cyclohexylacrylamide, vinyl methyl ether or acrylonitrile, and mixtures comprising at least one of the foregoing comonomers. Optionally, up to 5 wt. % a polyfunctional crosslinking comonomer may be present, for example divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, and the like, as well as combinations comprising at least one of the foregoing crosslinking agents.

The elastomer phase may be polymerized by mass, emulsion, suspension, solution or combined processes such as bulk-suspension, emulsion-bulk, bulk-solution or other techniques, using continuous, semibatch, or batch processes. The particle size of the elastomer substrate is not critical. For example, an average particle size of about 0.001 to about 25 micrometers, specifically about 0.01 to about 15 micrometers, or even more specifically about 0.1 to about 8 micrometers may be used for emulsion based polymerized rubber lattices. A particle size of about 0.5 to about 10 micrometers, specifically about 0.6 to about 1.5 micrometers may be used for bulk polymerized rubber substrates. Particle size may be measured by simple light transmission methods or capillary hydrodynamic chromatography (CHDF). The elastomer phase may be a particulate, moderately cross-linked conjugated butadiene or C₄₋₆ alkyl acrylate rubber, and preferably has a gel content greater than 70%. Also suitable are mixtures of butadiene with styrene and/or C₄₋₆ alkyl acrylate rubbers.

The elastomeric phase may provide about 5 wt. % to about 95 wt. % of the total graft copolymer, more specifically about 20 wt. % to about 90 wt. %, and even more specifically about 40 wt. % to about 85 wt. % of the elastomer-modified graft copolymer, the remainder being the rigid graft phase.

The rigid phase of the elastomer-modified graft copolymer may be formed by graft polymerization of a mixture comprising a monovinylaromatic monomer and optionally one or more comonomers in the presence of one or more elastomeric polymer substrates. The above-described monovinylaromatic monomers of formula (9) may be used in the rigid graft phase, including styrene, alpha-methyl styrene, halostyrenes such as dibromostyrene, vinyltoluene, vinylxylene, butylstyrene, para-hydroxystyrene, methoxystyrene, or the like, or combinations comprising at least one of the foregoing monovinylaromatic monomers. Suitable comonomers include, for example, the above-described monovinylic monomers and/or monomers of the general formula (10). In one embodiment, R is hydrogen or C₁-C₂ alkyl, and X^{d} is cyano or C₁-C₁₂ alkoxycarbonyl. Specific examples of suitable comonomers for use in the rigid phase include acrylonitrile, ethacrylonitrile, methacrylonitrile, methyl (meth)acrylate, ethyl (meth)acrylate, n-propyl (meth)acrylate, isopropyl (meth)acrylate, and the like, and combinations comprising at least one of the foregoing comonomers.

The relative ratio of monovinylaromatic monomer and comonomer in the rigid graft phase may vary widely depending on the type of elastomer substrate, type of monovinylaromatic monomer(s), type of comonomer(s), and the desired properties of the impact modifier. The rigid phase may generally comprise up to 100 wt. % of monovinyl aromatic monomer, specifically about 30 to about 100 wt. %, more specifically about 50 to about 90 wt. % monovinylaromatic monomer, with the balance being comonomer(s).

Depending on the amount of elastomer-modified polymer present, a separate matrix or continuous phase of ungrafted rigid polymer or copolymer may be simultaneously obtained along with the elastomer-modified graft copolymer. Typically, such impact modifiers comprise about 40 wt. % to about 95 wt. % elastomer-modified graft copolymer and about 5 wt. % to about 65 wt. % graft (co)polymer, based on the total weight of the impact modifier. In another embodiment, such impact modifiers comprise about 50 wt. % to about 85 wt. %, more specifically about 75 wt. % to about 85 wt. % rubber-modified graft copolymer, together with about 15 wt. % to about 50 wt. %, more specifically about 15 wt. % to about 25 wt. % graft (co)polymer, based on the total weight of the impact modifier.

Another specific type of elastomer-modified impact modifier comprises structural units derived from at least one silicone rubber monomer, a branched acrylate rubber monomer having the formula H₂C═C(R^{g})C(O)OCH₂CH₂R^{h}, wherein R^{g} is hydrogen or a C₁-C₈ linear or branched hydrocarbyl group and R^{h} is a branched C₃-C₁₆ hydrocarbyl group; a first graft link monomer; a polymerizable alkenyl-containing organic material; and a second graft link monomer. The silicone rubber monomer may comprise, for example, a cyclic siloxane, tetraalkoxysilane, trialkoxysilane, (acryloxy)alkoxysilane, (mercaptoalkyl)alkoxysilane, vinylalkoxysilane, or allylalkoxysilane, alone or in combination, e.g., decamethylcyclopentasiloxane, dodecamethylcyclohexasiloxane, trimethyltriphenylcyclotrisiloxane, tetramethyltetraphenylcyclotetrasiloxane, tetramethyltetravinylcyclotetrasiloxane, octaphenylcyclotetrasiloxane, octamethylcyclotetrasiloxane and/or tetraethoxysilane.

Exemplary branched acrylate rubber monomers include iso-octyl acrylate, 6-methyloctyl acrylate, 7-methyloctyl acrylate, 6-methylheptyl acrylate, and the like, alone or in combination. The polymerizable alkenyl-containing organic material may be, for example, a monomer of formula (9) or (10), e.g., styrene, alpha-methylstyrene, acrylonitrile, methacrylonitrile, or an unbranched (meth)acrylate such as methyl methacrylate, 2-ethylhexyl methacrylate, methyl acrylate, ethyl acrylate, n-propyl acrylate, or the like, alone or in combination.

The at least one first graft link monomer may be an (acryloxy)alkoxysilane, a (mercaptoalkyl)alkoxysilane, a vinylalkoxysilane, or an allylalkoxysilane, alone or in combination, e.g., (gamma-methacryloxypropyl)(dimethoxy)methylsilane and/or (3-mercaptopropyl)trimethoxysilane. The at least one second graft link monomer is a polyethylenically unsaturated compound having at least one allyl group, such as allyl methacrylate, triallyl cyanurate, or triallyl isocyanurate, alone or in combination.

The silicone-acrylate impact modifier compositions can be prepared by emulsion polymerization, wherein, for example at least one silicone rubber monomer is reacted with at least one first graft link monomer at a temperature from about 30° C. to about 110° C. to form a silicone rubber latex, in the presence of a surfactant such as dodecylbenzenesulfonic acid. Alternatively, a cyclic siloxane such as cyclooctamethyltetrasiloxane and a tetraethoxyorthosilicate may be reacted with a first graft link monomer such as (gamma-methaacryloxypropyl)methyldimethoxysilane, to afford silicone rubber having an average particle size from about 100 nanometers to about 2 micrometers. At least one branched acrylate rubber monomer is then polymerized with the silicone rubber particles, optionally in the presence of a cross linking monomer, such as allylmethacrylate in the presence of a free radical generating polymerization catalyst such as benzoyl peroxide. This latex is then reacted with a polymerizable alkenyl-containing organic material and a second graft link monomer. The latex particles of the graft silicone-acrylate rubber hybrid may be separated from the aqueous phase through coagulation (by treatment with a coagulant) and dried to a fine powder to produce the silicone-acrylate rubber impact modifier composition. This method can be generally used for producing the silicone-acrylate impact modifier having a particle size from about 100 nanometers to about two micrometers.

Processes known for the formation of the foregoing elastomer-modified graft copolymers include mass, emulsion, suspension, and solution processes, or combined processes such as bulk-suspension, emulsion-bulk, bulk-solution or other techniques, using continuous, semibatch, or batch processes.

In one embodiment the foregoing types of impact modifiers are prepared by an emulsion polymerization process that is free of basic materials such as alkali metal salts of C₆₋₃₀ fatty acids, for example sodium stearate, lithium stearate, sodium oleate, potassium oleate, and the like, alkali metal carbonates, amines such as dodecyl dimethyl amine, dodecyl amine, and the like, and ammonium salts of amines. Such materials are commonly used as surfactants in emulsion polymerization, and may catalyze transesterification and/or degradation of polycarbonates. Instead, ionic sulfate, sulfonate or phosphate surfactants may be used in preparing the impact modifiers, particularly the elastomeric substrate portion of the impact modifiers. Suitable surfactants include, for example, C₁₋₂₂ alkyl or C₇₋₂₅ alkylaryl sulfonates, C₁₋₂₂ alkyl or C₇₋₂₅ alkylaryl sulfates, C₁₋₂₂ alkyl or C₇₋₂₅ alkylaryl phosphates, substituted silicates, and mixtures thereof. A specific surfactant is a C₆₋₁₆, specifically a C₈₋₁₂ alkyl sulfonate. This emulsion polymerization process is described and disclosed in various patents and literature of such companies as Rohm & Haas and General Electric Company. In the practice, any of the above-described impact modifiers may be used providing it is free of the alkali metal salts of fatty acids, alkali metal carbonates and other basic materials.

A specific impact modifier of this type is a methyl methacrylate-butadiene-styrene (MBS) impact modifier wherein the butadiene substrate is prepared using above-described sulfonates, sulfates, or phosphates as surfactants. Other examples of elastomer-modified graft copolymers besides ABS and MBS include but are not limited to acrylonitrile-styrene-butyl acrylate (ASA), methyl methacrylate-acrylonitrile-butadiene-styrene (MABS), and acrylonitrile-ethylene-propylene-diene-styrene (AES).

In some embodiments, the impact modifier is a graft polymer having a high rubber content, i.e., greater than or equal to about 50 wt. %, optionally greater than or equal to about 60 wt. % by weight of the graft polymer. The rubber is preferably present in an amount less than or equal to about 95 wt. %, optionally less than or equal to about 90 wt. % of the graft polymer.

The rubber forms the backbone of the graft polymer, and is preferably a polymer of a conjugated diene having the formula (11): 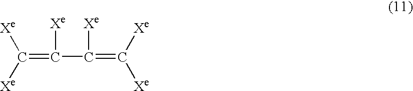
wherein X^{e} is hydrogen, C₁-C₅ alkyl, chlorine, or bromine. Examples of dienes that may be used are butadiene, isoprene, 1,3-hepta-diene, methyl-1,3-pentadiene, 2,3-dimethyl-1,3-butadiene, 2-ethyl-1,3-pentadiene; 1,3- and 2,4-hexadienes, chloro and bromo substituted butadienes such as dichlorobutadiene, bromobutadiene, dibromobutadiene, mixtures comprising at least one of the foregoing dienes, and the like. A preferred conjugated diene is butadiene. Copolymers of conjugated dienes with other monomers may also be used, for example copolymers of butadiene-styrene, butadiene-acrylonitrile, and the like. Alternatively, the backbone may be an acrylate rubber, such as one based on n-butyl acrylate, ethylacrylate, 2-ethylhexylacrylate, mixtures comprising at least one of the foregoing, and the like. Additionally, minor amounts of a diene may be copolymerized in the acrylate rubber backbone to yield improved grafting.

After formation of the backbone polymer, a grafting monomer is polymerized in the presence of the backbone polymer. One preferred type of grafting monomer is a monovinylaromatic hydrocarbon having the formula (12): 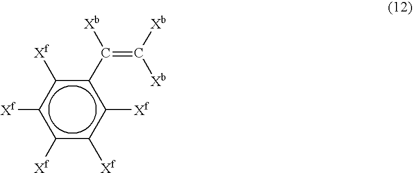
wherein X^{b} is as defined above and X^{f} is hydrogen, C₁-C₁₀ alkyl, C₁-C₁₀ cycloalkyl, C₁-C₁₀ alkoxy, C₆-C18 alkyl, C₆-C18 aralkyl, C₆-C₁₈ aryloxy, chlorine, bromine, and the like. Examples include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, mixtures comprising at least one of the foregoing compounds, and the like.

A second type of grafting monomer that may be polymerized in the presence of the polymer backbone are acrylic monomers of formula (13): 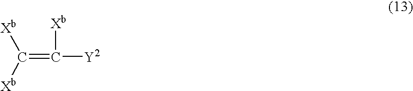
wherein X^{b} is as previously defined and Y² is cyano, C₁-C₁₂ alkoxycarbonyl, or the like. Examples of such acrylic monomers include acrylonitrile, ethacrylonitrile, methacrylonitrile, alpha-chloroacrylonitrile, beta-chloroacrylonitrile, alpha-bromoacrylonitrile, beta-bromoacrylonitrile, methyl acrylate, methyl methacrylate, ethyl acrylate, butyl acrylate, propyl acrylate, isopropyl acrylate, mixtures comprising at least one of the foregoing monomers, and the like.

A mixture of grafting monomers may also be used, to provide a graft copolymer. Preferred mixtures comprise a monovinylaromatic hydrocarbon and an acrylic monomer. Preferred graft copolymers include acrylonitrile-butadiene-styrene (ABS) and methacrylonitrile-butadiene-styrene (MBS) resins. Suitable high-rubber acrylonitrile-butadiene-styrene resins are available from General Electric Company as BLENDEX® grades 131, 336, 338, 360, and 415.

The composition also may include an aromatic vinyl copolymer, for example, a styrenic copolymer (also referred to as a “polystyrene copolymer”). The terms “aromatic vinyl copolymer” and “polystyrene copolymer” and “styrenic copolymer”, as used herein, include polymers prepared by methods known in the art including bulk, suspension, and emulsion polymerization employing at least one monovinyl aromatic hydrocarbon. The polystyrene copolymers may be random, block, or graft copolymers. Examples of monovinyl aromatic hydrocarbons include alkyl-, cycloalkyl-, aryl-, alkylaryl-, aralkyl-, alkoxy-, aryloxy-, and other substituted vinylaromatic compounds, as combinations thereof. Specific examples include: styrene, 4-methylstyrene, 3,5-diethylstyrene, 4-n-propylstyrene, α-methylstyrene, α-methylvinyltoluene, α-chlorostyrene, α-bromostyrene, dichlorostyrene, dibromostyrene, tetrachlorostyrene, and the like, and combinations thereof. The preferred monovinyl aromatic hydrocarbons used are styrene and α-methylstyrene.

The composition optionally contains an aromatic vinyl copolymer. The aromatic vinyl copolymer contains a comonomer, such as vinyl monomers, acrylic monomers, maleic anhydride and derivates, and the like, and combinations thereof. As defined herein, vinyl monomers are aliphatic compounds having at least one polymerizable carbon-carbon double bond. When two or more carbon-carbon double bonds are present, they may be conjugated to each other, or not. Suitable vinyl monomers include, for example, ethylene, propylene, butenes (including 1-butene, 2-butene, and isobutene), pentenes, hexenes, and the like; 1,3-butadiene, 2-methyl-1,3-butadiene (isoprene), 1,4-pentadiene, 1,5-hexadiene, and the like; and combinations thereof.

Acrylic monomers include, for example, acrylonitrile, ethacrylonitrile, methacrylonitrile, α-chloroarylonitrile, β-chloroacrylonitrile, α-bromoacrylonitrile, and β-bromoacrylonitrile, methyl acrylate, methyl methacrylate, ethyl acrylate, butyl acrylate, propylacrylate, isopropyl acrylate, and the like, and mixtures thereof.

Maleic anhydride and derivatives thereof include, for example, maleic anhydride, maleimide, N-alkyl maleimide, N-aryl maleimide or the alkyl- or halo-substituted N-arylmaleimides, and the like, and combinations thereof.

The amount of comonomer(s) present in the aromatic vinyl copolymer can vary. However, the level is generally present at a mole percentage of about 2% to about 75%. Within this range, the mole percentage of comonomer may specifically be at least 4%, more specifically at least 6%. Also within this range, the mole percentage of comonomer may specifically be up to about 50%, more specifically up to about 25%, even more specifically up to about 15%. Specific polystyrene copolymer resins include poly(styrene maleic anhydride), commonly referred to as “SMA” and poly(styrene acrylonitrile), commonly referred to as “SAN”.

In one embodiment, the aromatic vinyl copolymer comprises (a) an aromatic vinyl monomer component and (b) a cyanide vinyl monomer component. Examples of (a) the aromatic vinyl monomer component include a-methylstyrene, o-, m-, or p-methylstyrene, vinyl xylene, monochlorostyrene, dichlorostyrene, monobromostyrene, dibromostyrene, fluorostyrene, p-tert-butylstyrene, ethylstyrene, and vinyl naphthalene, and these substances may be used individually or in combinations. Examples of (b) the cyanide vinyl monomer component include acrylonitrile and methacrylonitrile, and these may be used individually or in combinations of two or more. There are no particular restrictions on the composition ratio of (a) to (b) in the aromatic vinyl copolymer thereof, and this ratio should be selected according to the application in question. Optionally, the aromatic vinyl copolymer can contain about 95 wt. % to about 50 wt. % (a), optionally about 92 wt. % to about 65 wt. % (a) by weight of (a)+(b) in the aromatic vinyl copolymer and, correspondingly, about 5 wt. % to about 50 wt. % (b), optionally about 8 wt. % to about 35 wt. % (b) by weight of (a)+(b) in the aromatic vinyl copolymer.

The weight average molecular weight (Mw) of the aromatic vinyl copolymer can be 30,000 to 200,000, optionally 30,000 to 110,000, measured by gel permeation chromatography.

Methods for manufacturing the aromatic vinyl copolymer include bulk polymerization, solution polymerization, suspension polymerization, bulk suspension polymerization and emulsion polymerization. Moreover, the individually copolymerized resins may also be blended. The alkali metal content of the aromatic vinyl copolymer can be about 1 ppm or less, optionally about 0.5 ppm or less, for example, about 0.1 ppm or less, by weight of the aromatic vinyl copolymer. Moreover, among alkali metals, the content of sodium and potassium in component (b) can be about 1 ppm or less, and optionally about 0.5 ppm or less, for example, about 0.1 ppm or less.

In one embodiment, the aromatic vinyl copolymer comprises “free” styrene-acrylonitrile copolymer (SAN), i.e., styrene-acrylonitrile copolymer that is not grafted onto another polymeric chain. In a particular embodiment, the free styrene-acrylonitrile copolymer may have a molecular weight of 50,000 to about 200,000 on a polystyrene standard molecular weight scale and may comprise various proportions of styrene to acrylonitrile. For example, free SAN may comprise about 75 wt. % styrene and about 25 wt. % acrylonitrile based on the total weight of the free SAN copolymer. Free SAN may optionally be present by virtue of the addition of a grafted rubber impact modifier in the composition that contains free SAN, and/or free SAN may by present independent of the impact modifier in the composition.

The composition may comprise about 2 wt. % to about 25 wt. % free SAN, optionally about 2 wt. % to about 20 wt. % free SAN, for example, about 5 wt. % to about 15 wt. % free SAN or, optionally,-about 7.5 wt. % to about 10 wt. % free SAN, by weight of the composition as shown in the examples herein.

The composition also includes at least one mineral filler. A non-exhaustive list of examples of mineral fillers suitable for use in the composition include, but are not limited to, talc, mica, wollastonite, clay and the like. Combinations of fillers may also be used. As used herein, the term “mineral filler” includes any synthetic and naturally occurring reinforcing agents for polycarbonates and polycarbonate blends that can be combined with an acid or acid salt for a synergistic effect that produces balanced physical properties and does not degrade the polycarbonate or polycarbonate blend.

The composition also includes an acid or an acid salt. In one embodiment, the acid or acid salt is an inorganic acid or inorganic acid salt. In one embodiment, the acid is an acid comprising a phosphorous containing oxy-acid.

In one embodiment, the phosphorous containing oxy-acid is a multi-protic phosphorus containing oxy-acid having the general formula (14):
HₘPₜOₙ (14)
where m and n are each 2 or greater and t is 1 or greater.

Examples of the acids of formula (14) include, but are not limited to, acids represented by the following formulas: H₃PO₄, H₃PO₃, and H₃PO₂. In some embodiments, the acid will include one of the following: phosphoric acid, phosphorous acid, hypophosphorous acid, hypophosphoric acid, phosphinic acid, phosphonic acid, metaphosphoric acid, hexametaphosphoric acid, thiophosphoric acid, fluorophosphoric acid, difluorophosphoric acid, fluorophosphorous acid, difluorophosphorous acid, fluorohypophosphorous acid, or fluorohypophosphoric acid. Alternatively, acids and acid salts, such as, for example, sulphuric acid, sulphites, mono zinc phosphate, mono calcium phosphate, mono natrium phosphate, and the like, may be used. The acid or acid salt is preferably selected so that it can be effectively combined with the mineral filler to produce a synergistic effect and a balance of properties, such as flow and impact, in the polycarbonate or polycarbonate blend.

Other fillers and/or reinforcing agents may be used if desired, as long as they do not further degrade the composition. Suitable fillers or reinforcing agents include any materials known for these uses. For example, suitable fillers and reinforcing agents include silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

The fillers and reinforcing agents may be coated with a layer of metallic material to facilitate conductivity, or surface treated with silanes to improve adhesion and dispersion with the polymeric matrix resin. In addition, the reinforcing fillers may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous fillers may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids. Fillers are generally used in amounts of about zero to about 50 parts by weight, optionally about 1 to about 20 parts by weight, and in some embodiments, about 4 to about 15 parts by weight, based on 100 parts by weight of the polycarbonate resin, the aromatic vinyl copolymer and any impact modifier.

The composition may optionally comprise other polycarbonate blends and copolymers, such as polycarbonate-polysiloxane copolymers, esters and the like.

In addition to the polycarbonate resin, the filler and the acid, the thermoplastic composition may include various additives ordinarily incorporated in resin compositions of this type, with the proviso that the additives are preferably selected so as to not significantly adversely affect the desired properties of the thermoplastic composition. Mixtures of additives may be used. Such additives may be mixed at a suitable time during the mixing of the components for forming the composition.

The thermoplastic composition may optionally comprise a cycloaliphatic polyester resin. The cycloaliphatic polyester resin comprises a polyester having repeating units of the formula (15): 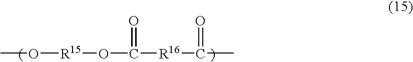
where at least one R¹⁵ or R¹⁶ is a cycloalkyl containing radical.

The polyester is a condensation product where R¹⁵ is the residue of an aryl, alkane or cycloalkane containing diol having 6 to 20 carbon atoms or chemical equivalent thereof, and R¹⁶ is the decarboxylated residue derived from an aryl, aliphatic or cycloalkane containing diacid of 6 to 20 carbon atoms or chemical equivalent thereof with the proviso that at least one R¹⁵ or R¹⁶ is cycloaliphatic. Preferred polyesters of the invention will have both R¹⁵ and R¹⁶ cycloaliphatic.

Cycloaliphatic polyesters are condensation products of aliphatic diacids, or chemical equivalents and aliphatic diols, or chemical equivalents. Cycloaliphatic polyesters may be formed from mixtures of aliphatic diacids and aliphatic diols but must contain at least 50 mole % of cyclic diacid and/or cyclic diol components, the remainder, if any, being linear aliphatic diacids and/or diols.

The polyester resins are typically obtained through the condensation or ester interchange polymerization of the diol or diol equivalent component with the diacid or diacid chemical equivalent component.

R¹⁵ and R¹⁶ are preferably cycloalkyl radicals independently selected from the following formula:

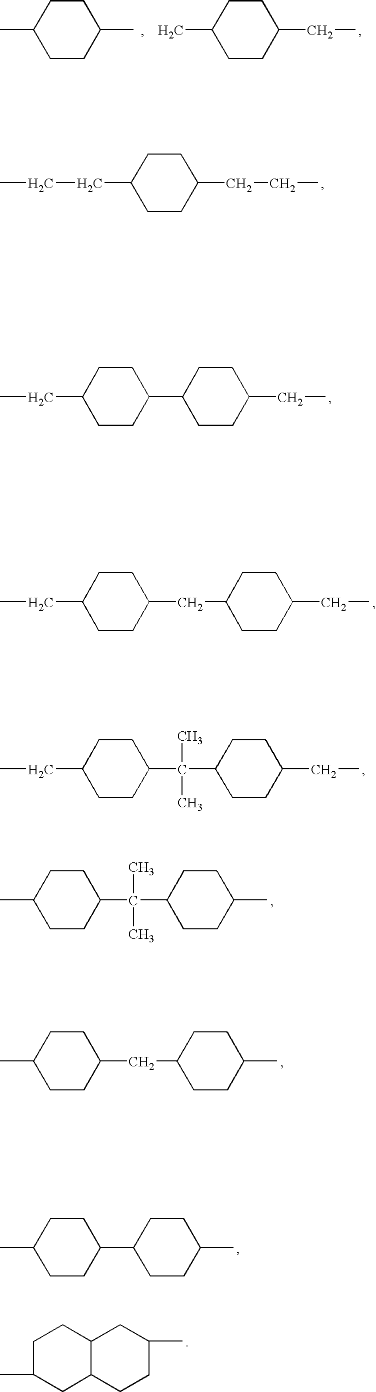

The preferred cycloaliphatic radical R¹⁶ is derived from the 1,4-cyclohexyl diacids and most preferably greater than 70 mole % thereof in the form of the trans isomer. The preferred cycloaliphatic radical R¹⁵ is derived from the 1,4-cyclohexyl primary diols such as 1,4-cyclohexyl dimethanol, most preferably more than 70 mole % thereof in the form of the trans isomer.

Other diols useful in the preparation of the polyester resins of the present invention are straight chain, branched, or cycloaliphatic alkane diols and may contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; 2,2,4,4-tetramethyl-1,3-cyclobutanediol (TMCBD), triethylene glycol; 1,10-decane diol; and mixtures of any of the foregoing. Preferably a cycloaliphatic diol or chemical equivalent thereof and particularly 1,4-cyclohexane dimethanol or its chemical equivalents are used as the diol component.

Chemical equivalents to the diols include esters, such as dialkylesters, diaryl esters and the like.

The diacids useful in the preparation of the aliphatic polyester resins of the present invention preferably are cycloaliphatic diacids. This is meant to include carboxylic acids having two carboxyl groups each of which is attached to a saturated carbon. Preferred diacids are cyclo or bicyclo aliphatic acids, for example, decahydro naphthalene dicarboxylic acids, norbomene dicarboxylic acids, bicyclo octane dicarboxylic acids, 1,4-cyclohexanedicarboxylic acid or chemical equivalents, and most preferred is trans-1,4-cyclohexanedicarboxylic acid or chemical equivalent. Linear dicarboxylic acids like adipic acid, azelaic acid, dicarboxyl dodecanoic acid and succinic acid may also be useful.

Cyclohexane dicarboxylic acids and their chemical equivalents can be prepared, for example, by the hydrogenation of cycloaromatic diacids and corresponding derivatives such as isophthalic acid, terephthalic acid or naphthalenic acid in a suitable solvent such as water or acetic acid using a suitable catalysts such as rhodium supported on a carrier such as carbon or alumina. They may also be prepared by the use of an inert liquid medium in which a phthalic acid is at least partially soluble under reaction conditions and with a catalyst of palladium or ruthenium on carbon or silica.

Typically, in the hydrogenation, two isomers are obtained in which the carboxylic acid groups are in cis- or trans-positions. The cis- and trans-isomers can be separated by crystallization with or without a solvent, for example, n-heptane, or by distillation. The cis-isomer tends to blend better; however, the trans-isomer has higher melting and crystallization temperatures and may be preferred. Mixtures of the cis- and trans-isomers are useful herein as well.

When the mixture of isomers or more than one diacid or diol is used, a copolyester or a mixture of two polyesters may be used as the present cycloaliphatic polyester resin.

Chemical equivalents of these diacids include esters, alkyl esters, e.g., dialkyl esters, diaryl esters, anhydrides, salts, acid chlorides, acid bromides, and the like. The preferred chemical equivalents comprise the dialkyl esters of the cycloaliphatic diacids, and the most favored chemical equivalent comprises the dimethyl ester of the acid, particularly dimethyl-1,4-cyclohexane-dicarboxylate.

A preferred cycloaliphatic polyester is poly(cyclohexane-1,4-dimethylene cyclohexane-1,4-dicarboxylate) also referred to as poly(1,4-cyclohexane-dimethanol-1,4-dicarboxylate) (PCCD) which has recurring units of formula (16):

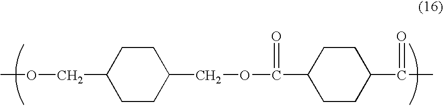

With reference to the previously set forth general formula, for PCCD, R¹⁵ is derived from 1,4 cyclohexane dimethanol; and R¹⁶ is a cyclohexane ring derived from cyclohexanedicarboxylate or a chemical equivalent thereof. The favored PCCD has a cis/trans formula.

The polyester polymerization reaction is generally run in the melt in the presence of a suitable catalyst such as a tetrakis (2-ethyl hexyl) titanate, in a suitable amount, typically about 50 to 200 ppm of titanium based upon the final product.

The preferred aliphatic polyesters have a glass transition temperature (Tg) which is above 50° C., more preferably above 80° C. and most preferably above about

Also contemplated herein are the above polyesters with about 1 to about 50 percent by weight, of units derived from polymeric aliphatic acids and/or polymeric aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

The composition further comprises a polycarbonate-polysiloxane copolymer comprising polycarbonate blocks and polydiorganosiloxane blocks. The polycarbonate blocks in the copolymer comprise repeating structural units of formula (1) as described above, for example wherein R¹ is of formula (2) as described above. These units may be derived from reaction of dihydroxy compounds of formula (3) as described above. In one embodiment, the dihydroxy compound is bisphenol A, in which each of A¹ and A² is p-phenylene and Y¹ is isopropylidene.

The polydiorganosiloxane blocks comprise repeating structural units of formula (17) (sometimes referred to herein as ‘siloxane’): 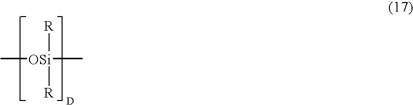
wherein each occurrence of R is same or different, and is a C₁₋₁₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₀ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. Combinations of the foregoing R groups may be used in the same copolymer.

The value of D in formula (17) may vary widely depending on the type and relative amount of each component in the thermoplastic composition, the desired properties of the composition, and like considerations. Generally, D may have an average value of 2 to about 1000, specifically about 2 to about 500, more specifically about 5 to about 100. In one embodiment, D has an average value of about 10 to about 75, and in still another embodiment, D has an average value of about 40 to about 60. Where D is of a lower value, e.g., less than about 40, it may be desirable to use a relatively larger amount of the polycarbonate-polysiloxane copolymer. Conversely, where D is of a higher value, e.g., greater than about 40, it may be necessary to use a relatively lower amount of the polycarbonate-polysiloxane copolymer.

A combination of a first and a second (or more) polycarbonate-polysiloxane copolymers may be used, wherein the average value of D of the first copolymer is less than the average value of D of the second copolymer.

In one embodiment, the polydiorganosiloxane blocks are provided by repeating structural units of formula (18): 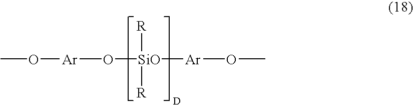
wherein D is as defined above; each R may be the same or different, and is as defined above; and Ar may be the same or different, and is a substituted or unsubstituted C₆-C₃₀ arylene radical, wherein the bonds are directly connected to an aromatic moiety. Suitable Ar groups in formula (9) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of suitable dihydroxyarlyene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulphide), and 1,1-bis(4-hydroxy-t-butylphenyl) propane. Combinations comprising at least one of the foregoing dihydroxy compounds may also be used.

Such units may be derived from the corresponding dihydroxy compound of the following formula (19): 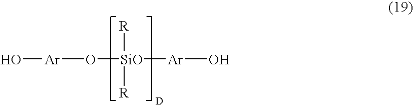
wherein Ar and D are as described above. Such compounds are further described in U.S. Pat. No. 4,746,701 to Kress et al. Compounds of this formula may be obtained by the reaction of a dihydroxyarylene compound with, for example, an alpha, omega-bisacetoxypolydiorangonosiloxane under phase transfer conditions.

In another embodiment the polydiorganosiloxane blocks comprise repeating structural units of formula (20): 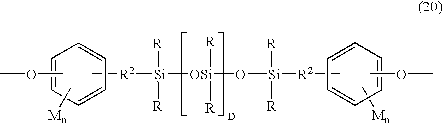
wherein R and D are as defined above. R² in formula (20) is a divalent C₂-C₈ aliphatic group. Each M in formula (20) may be the same or different, and may be a halogen, cyano, nitro, C₁-C₈ alkylthio, C₁-C8 alkyl, C₁-C₈ alkoxy, C₂-C₈ alkenyl, C₂-C8 alkenyloxy group, C₃-C8 cycloalkyl, C₃-C₈ cycloalkoxy, C₆-C₁₀ aryl, C₆-C₁₀ aryloxy, C₇-C₂ aralkyl C₇-C₁₂ aralkoxy, C₇-C₁₂ alkaryl, or C₇-C₁₂ alkaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R² is a divalent C₁-C₃ aliphatic group, and R is methyl.

These units may be derived from the corresponding dihydroxy polydiorganosiloxane (21): 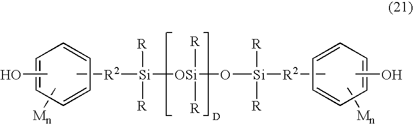
wherein R, D, M, R², and n are as described above.

Such dihydroxy polysiloxanes can be made by effecting a platinum catalyzed addition between a siloxane hydride of the formula (22), 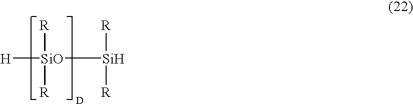
wherein R and D are as previously defined, and an aliphatically unsaturated monohydric phenol. Suitable aliphatically unsaturated monohydric phenols included, for example, eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

The polycarbonate-polysiloxane copolymer may be manufactured by reaction of diphenolic polysiloxane (21) with a carbonate source and a dihydroxy aromatic compound of formula (3), optionally in the presence of a phase transfer catalyst as described above. Suitable conditions are similar to those useful in forming polycarbonates. For example, the copolymers are prepared by phosgenation, at temperatures from below 0° C. to about 100° C., preferably about 25° C. to about 50° C. Since the reaction is exothermic, the rate of phosgene addition may be used to control the reaction temperature. The amount of phosgene required will generally depend upon the amount of the dihydric reactants. Alternatively, the polycarbonate-polysiloxane copolymers may be prepared by co-reacting in a molten state, the dihydroxy monomers and a diaryl carbonate ester, such as diphenyl carbonate, in the presence of a transesterification catalyst as described above.

In the production of the polycarbonate-polysiloxane copolymer, the amount of dihydroxy polydiorganosiloxane is selected so as to provide the desired amount of polydiorganosiloxane units in the copolymer. The amount of polydiorganosiloxane units may vary widely, i.e., may be about 1 wt. % to about 99 wt. % of polydimethylsiloxane, or an equivalent molar amount of another polydiorganosiloxane, with the balance being carbonate units. The particular amounts used will therefore be determined depending on desired physical properties of the thermoplastic composition, the value of D (within the range of 2 to about 1000), and the type and relative amount of each component in the thermoplastic composition, including the type and amount of polycarbonate, type and amount of impact modifier, type and amount of polycarbonate-polysiloxane copolymer, and type and amount of any other additives. Suitable amounts of dihydroxy polydiorganosiloxane can be determined by one of ordinary skill in the art without undue experimentation using the guidelines taught herein. For example, the amount of dihydroxy polydiorganosiloxane may be selected so as to produce a copolymer comprising about 1 wt. % to about 75 wt. %, or about 1 wt. % to about 50 wt. % polydimethylsiloxane, or an equivalent molar amount of another polydiorganosiloxane. In one embodiment, the copolymer comprises about 5 wt. % to about 40 wt. %, optionally about 5 wt. % to about 25 wt. % polydimethylsiloxane, or an equivalent molar amount of another polydiorganosiloxane, with the balance being polycarbonate. In a particular embodiment, the copolymer may comprise about 20 wt. % siloxane.

In various embodiments, the thermoplastic composition comprises about 30 wt. % to about 99 wt. % polycarbonate resin; optionally about 40 wt. % to about 95 wt. % polycarbonate; optionally about 45 wt. % to 85 wt. % polycarbonate. The thermoplastic composition can also comprise less than about 60 wt. % impact modifier; optionally about 0.1 wt. % to about 50 wt. % impact modifier; and in some embodiments about 2 wt. % to about 40 wt. % impact modifier. The composition may further contain about 1 wt. % to 50 wt. % mineral filler, optionally about 3 wt. % to about 40 wt. % mineral filler and in some embodiments, about 5 wt. % to about 20 wt. % mineral filler. The composition may further comprise about 0.01 wt. % to about 5 wt. % acid, optionally about 0.05 wt. % to about 2 wt. %, and in some embodiments about 0.1 wt. % to about 1 wt. % acid. The thermoplastic composition may optionally comprise about 5 wt. % to about 40 wt. % aromatic vinyl copolymer; optionally about 5 wt. % to about 30 wt. % aromatic vinyl copolymer and in some embodiments about 5 wt. % to about 25 wt. % aromatic vinyl copolymer. The weight ratio of acid to filler in the composition should be at least 0.0035:1; optionally at least 0.005:1; optionally at least 0.0075:1; optionally at least 0.015:1; optionally, at least 0.03:1; optionally at least 0.06:1; optionally at least 0.12: 1; depending on the desired balance of properties. All of the foregoing wt. % values are based on the combined weight of the polycarbonate resin, the mineral filler, the acid, and optionally, the impact modifier and/or the aromatic vinyl copolymer. In illustrative embodiments, a composition may comprise about 50 wt. % to about 98 wt. % polycarbonate resin, about 2 to about 20 wt. % talc, about 0.05 wt. % to about 2 wt. % phosphorous acid; or a composition may comprise about 50 wt. % to about 90 wt. % polycarbonate resin, about 1 wt. % to about 10 wt. % ABS, about 5 wt. % to about 20 wt. % talc, about 0.05 wt. % to about 2 wt. % phosphorous acid, and optionally about 5 wt. % to about 20 wt. % SAN.

The compositions described herein may comprise a primary antioxidant or “stabilizer” (e.g., a hindered phenol and/or secondary aryl amine) and, optionally, a secondary antioxidant (e.g., a phosphate and/or thioester). Suitable antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of about 0.01 to about 1 parts by weight, optionally about 0.05 to about 0.5 parts by weight, based on 100 parts by weight polycarbonate resin, and any optional aromatic vinyl copolymer and/or impact modifier.

Suitable heat stabilizer additives include, for example, organophosphites such as triphenyl phosphite, tris-(2,6-dimethylphenyl)phosphite, tris-(mixed mono-and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers are generally used in amounts of about 0.01 to about 5 parts by weight, optionally about 0.05 to about 0.3 parts by weight, based on 100 parts by weight of polycarbonate resin, and any optional aromatic vinyl copolymer and/or impact modifier.

Light stabilizers and/or ultraviolet light (UV) absorbing additives may also be used. Suitable light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers are generally used in amounts of about 0.01 to about 10 parts by weight, optionally about 0.1 to about 1 parts by weight, based on 100 parts by weight of polycarbonate resin, aromatic vinyl copolymer and/or impact modifier.

Suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4- phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3, 3 -diphenylacryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than about 100 nanometers; or the like, or combinations comprising at least one of the foregoing UV absorbers. UV absorbers are generally used in amounts of about 0.1 to about 5 parts by weight, based on 100 parts by weight of polycarbonate resin, and any optional aromatic vinyl copolymer and/or impact modifier.

Plasticizers, lubricants, and/or mold release agents additives may also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials are generally used in amounts of about 0.1 to about 20 parts by weight, optionally about 1 to about 10 parts by weight, based on 100 parts by weight of the polycarbonate resin, and any optional aromatic vinyl copolymer and/or impact modifier.

The term “antistatic agent” refers to monomeric, oligomeric, or polymeric materials that can be processed into polymer resins and/or sprayed onto materials or articles to improve conductive properties and overall physical performance. Examples of monomeric antistatic agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents include certain polyesteramides, polyether-polyamide (polyetheramide) block copolymers, polyetheresteramide block copolymers, polyetheresters, or polyurethanes, each containing polyalkylene glycol moieties such as polyethylene glycol, polypropylene glycol, polytetramethylene glycol, and the like. Such polymeric antistatic agents are commercially available, such as, for example, Pelestat™ 6321 (Sanyo), Pebax™ MH1657 (Atofina), and Irgastat™ P18 and P22 (Ciba-Geigy). Other polymeric materials that may be used as antistatic agents are inherently conducting polymers such as polyaniline (commercially available as PANIPOL®EB from Panipol), polypyrrole and polythiophene (commercially available from Bayer), which retain some of their intrinsic conductivity after melt processing at elevated temperatures. In one embodiment, carbon fibers, carbon nanofibers, carbon nanotubes, carbon black, or any combination of the foregoing may be used in a polymeric resin containing chemical antistatic agents to render the composition electrostatically dissipative. Antistatic agents are generally used in amounts of about 0.1 to about 10 parts by weight, based on 100 parts by weight of polycarbonate resin, and any optional aromatic vinyl copolymer and/or impact modifier.

Colorants such as pigment and/or dye additives may also be present. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments. Pigments are generally used in amounts of about 0.01 to about 10 parts by weight, based on 100 parts by weight of polycarbonate resin, and any optional aromatic vinyl copolymer and/or impact modifier.

Suitable dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene; chrysene; rubrene; coronene, or the like, or combinations comprising at least one of the foregoing dyes. Dyes are generally used in amounts of about 0.1 to about 10 ppm, based on the weight of polycarbonate resin, and any optional aromatic vinyl copolymer and/or impact modifier.

Suitable flame retardants that may be added may be organic compounds that include phosphorus, bromine, and/or chlorine. Non-brominated and non-chlorinated phosphorus-containing flame retardants may be preferred in certain applications for regulatory reasons, for example organic phosphates and organic compounds containing phosphorus-nitrogen bonds.

One type of exemplary organic phosphate is an aromatic phosphate of the formula (GO)₃P═O, wherein each G is independently an alkyl, cycloalkyl, aryl, alkaryl, or aralkyl group, provided that at least one G is an aromatic group. Two of the G groups may be joined together to provide a cyclic group, for example, diphenyl pentaerythritol diphosphate, which is described by Axelrod in U.S. Pat. No. 4,154,775. Other suitable aromatic phosphates may be, for example, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

Di- or polyfunctional aromatic phosphorus-containing compounds are also useful, for example, compounds of the formulas below: 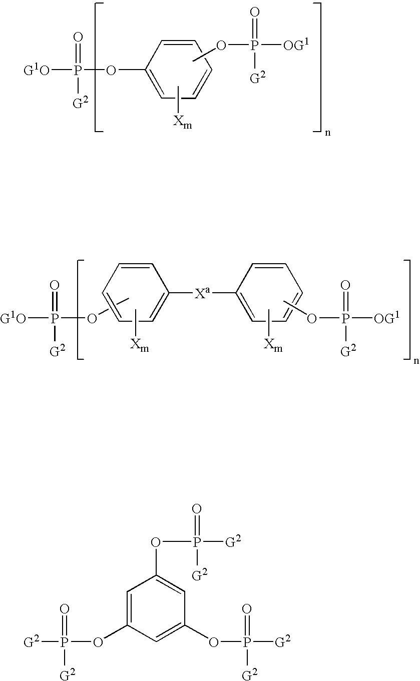
wherein each G¹ is independently a hydrocarbon having 1 to about 30 carbon atoms; each G2 is independently a hydrocarbon or hydrocarbonoxy having 1 to about 30 carbon atoms; each X^{a} is as defined above; each X is independently a bromine or chlorine; m is 0 to 4, and n is 1 to about 30. Examples of suitable di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like.

Exemplary suitable flame retardant compounds containing phosphorus-nitrogen bonds include phosphonitrilic chloride, phosphorus ester amides, phosphoric acid amides, phosphonic acid amides, phosphinic acid amides, tris(aziridinyl) phosphine oxide.

Halogenated materials may also be used as flame retardants, for example halogenated compounds and resins of formula (23): 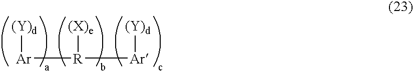
wherein R is an alkylene, alkylidene or cycloaliphatic linkage, e.g., methylene, ethylene, propylene, isopropylene, isopropylidene, butylene, isobutylene, amylene, cyclohexylene, cyclopentylidene, or the like; or an oxygen ether, carbonyl, amine, or a sulfur containing linkage, e.g., sulfide, sulfoxide, sulfone, or the like. R can also consist of two or more alkylene or alkylidene linkages connected by such groups as aromatic, amino, ether, carbonyl, sulfide, sulfoxide, sulfone, or the like.

Ar and Ar′ in formula (23) are each independently mono- or polycarbocyclic aromatic groups such as phenylene, biphenylene, terphenylene, naphthylene, or the like.

Y is an organic, inorganic, or organometallic radical, for example (1) halogen, e.g., chlorine, bromine, iodine, fluorine or (2) ether groups of the general formula OE, wherein E is a monovalent hydrocarbon radical similar to X or (3) monovalent hydrocarbon groups of the type represented by R or (4) other substituents, e.g., nitro, cyano, and the like, said substituents being essentially inert provided that there is at least one and optionally two halogen atoms per aryl nucleus.

When present, each X is independently a monovalent hydrocarbon group, for example an alkyl group such as methyl, ethyl, propyl, isopropyl, butyl, decyl, or the like; an aryl groups such as phenyl, naphthyl, biphenyl, xylyl, tolyl, or the like; and aralkyl group such as benzyl, ethylphenyl, or the like; a cycloaliphatic group such as cyclopentyl, cyclohexyl, or the like. The monovalent hydrocarbon group may itself contain inert substituents.

Each d is independently 1 to a maximum equivalent to the number of replaceable hydrogens substituted on the aromatic rings comprising Ar or Ar′. Each e is independently 0 to a maximum equivalent to the number of replaceable hydrogens on R. Each a, b, and c is independently a whole number, including 0. When b is not 0, neither a nor c may be 0. Otherwise either a or c, but not both, may be 0. Where b is 0, the aromatic groups are joined by a direct carbon-carbon bond.

The hydroxyl and Y substituents on the aromatic groups, Ar and Ar′ can be varied in the ortho, meta or para positions on the aromatic rings and the groups can be in any possible geometric relationship with respect to one another.

Included within the scope of the above formula are bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2 bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, may also be used with the flame retardant.

Inorganic flame retardants may also be used, for example salts of C₂₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate, and the like; salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or a fluoro-anion complex such as Li₃AlF₆, BaSiF₆, KBF₄, K₃AlF₆, KAlF₄, K₂SiF₆, and/or Na₃AlF₆ or the like.

Another useful type of flame retardant is a polysiloxane-polycarbonate copolymer having polydiorganosiloxane blocks comprising repeating structural units of formula (24): 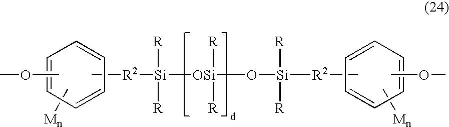
wherein each occurrence of R is the same as or different from the others, and is a C₁₋₁₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₀ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. Combinations of the foregoing R groups may be used in the same copolymer. R² in formula (24) is a divalent C₁-C₈ aliphatic group. Each M in formula (24) may be the same or different, and may be a halogen, cyano, nitro, C₁-C₈ alkylthio, C₁-C₈ alkyl, C₁-C₈ alkoxy, C₂-C8 alkenyl, C₂-C8 alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alka wherein each n is independently 0, 1, 2, 3, or 4.

Subscript d in formula (24) is selected so as to provide an effective level of flame retardance to the thermoplastic composition. The value of d will therefore vary depending on the type and relative amount of each component in the thermoplastic composition, including the type and amount of polycarbonate, impact modifier, polysiloxane-polycarbonate copolymer, and other flame retardants. Suitable values for d may be determined by one of ordinary skill in the art without undue experimentation using the guidelines taught herein. Generally, d has an average value of 2 to about 1000, specifically about 10 to about 100, more specifically about 25 to about 75. In one embodiment, d has an average value of about 40 to about 60, and in still another embodiment, d has an average value of about 50. Where d is of a lower value, e.g., less than about 40, it may be necessary to use a relatively larger amount of the polysiloxane-polycarbonate copolymer. Conversely, where d is of a higher value, for example, greater than about 40, it may be necessary to use a relatively smaller amount of the polysiloxane-polycarbonate copolymer.

In one embodiment, M is independently bromo or chloro, a C₁-C₃ alkyl group such as methyl, ethyl, or propyl, a C₁-C₃ alkoxy group such as methoxy, ethoxy, or propoxy, or a C₆-C₇ aryl group such as phenyl, chlorophenyl, or tolyl; R is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R² is a divalent C₁-C₃ aliphatic group, and R is methyl.

The polysiloxane-polycarbonate copolymer may be manufactured by reaction of the corresponding dihydroxy polysiloxane with a carbonate source and a dihydroxy aromatic compound of formula (3), optionally in the presence of a phase transfer catalyst as described above. Suitable conditions are similar to those useful in forming polycarbonates. Alternatively, the polysiloxane-polycarbonate copolymers may be prepared by co-reacting in a molten state, the dihydroxy monomers and a diaryl carbonate ester, such as diphenyl carbonate, in the presence of a transesterification catalyst as described above. Generally, the amount of dihydroxy polydiorganosiloxane is selected so as to produce a copolymer comprising about 1 to about 60 mole percent of polydiorganosiloxane blocks relative to the moles of polycarbonate blocks, and more generally, about 3 to about 50 mole percent of polydiorganosiloxane blocks relative to the moles of polycarbonate blocks.

Anti-drip agents may also be used, for example a fibril forming or non-fibril forming fluoropolymer such as polytetrafluoroethylene (PTFE). The anti-drip agent may be encapsulated by a rigid copolymer as described above, for example SAN. PTFE encapsulated in SAN is known as TSAN. Encapsulated fluoropolymers may be made by polymerizing the encapsulating polymer in the presence of the fluoropolymer, for example, in? an aqueous dispersion. TSAN may provide significant advantages over PTFE, in that TSAN may be more readily dispersed in the composition. A suitable TSAN may comprise, for example, about 50 wt. % PTFE and about 50 wt. % SAN, based on the total weight of the encapsulated fluoropolymer. The SAN may comprise, for example, about 75 wt. % styrene and about 25 wt. % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer.

Where a foam is desired, suitable blowing agents include, for example, low boiling halohydrocarbons and those that generate carbon dioxide; blowing agents that are solid at room temperature and when heated to temperatures higher than their decomposition temperature, generate gases such as nitrogen, carbon dioxide or ammonia gas, such as azodicarbonamide, metal salts of azodicarbonamide, 4,4′ oxybis(benzenesulfonylhydrazide), sodium bicarbonate, ammonium carbonate, or the like; or combinations comprising at least one of the foregoing blowing agents.

The thermoplastic compositions may be manufactured by methods generally available in the art, for example, in one embodiment, in one manner of proceeding, powdered polycarbonate resin, mineral filler, acid or acid salt, optional impact modifier, optional aromatic vinyl copolymer and any other optional components are first blended, optionally with other fillers in a Henschel™ high speed mixer or other suitable mixer/blender. Other low shear processes including but not limited to hand mixing may also accomplish this blending. The blend is then fed into the throat of a twin-screw extruder via a hopper. Alternatively, one or more of the components may be incorporated into the composition by feeding directly into the extruder at the throat and/or downstream through a sidestuffer. Such additives may also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate may be one-fourth inch long or less as desired. Such pellets may be used for subsequent molding, shaping, or forming.

Shaped, formed, or molded articles comprising the polycarbonate compositions are also provided. The polycarbonate compositions may be molded into useful shaped articles by a variety of means such as injection molding, extrusion, rotational molding, blow molding and thermoforming to form articles such as, for example, computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, electronic device casings and signs and the like. In addition, the polycarbonate compositions may be used for such applications as automotive panel and trim.

The compositions are further illustrated by the following non-limiting examples, which were prepared from the components set forth in Table 1.

TABLE 1

| Material | Description | Source |
|---|---|---|
| Polycarbonate | BPA polycarbonate resin made by the interfacial | GE Advanced |
| (PC-1) (PC175) | process with an MVR at 300° C./1.2 kg, of 23.5-28.5 g/ | Materials |
| | 10 min | |
| Polycarbonate | BPA polycarbonate resin made by the interfacial | GE Advanced |
| (PC-2) (PC105) | process with an MVR at 300° C./1.2 kg, of 5.1-6.9 g/ | Materials |
| | 10 min. | |
| Polycarbonate | Blend of 25% high flow PC-1 and 75% low flow | GE Advanced |
| Blend (PC-3) | PC-2 | Materials |
| Polycarbonate | Blend of 30% high flow PC-1 and 70% low flow | GE Advanced |
| Blend (PC-4) | PC-2 | Materials |
| Polycarbonate | BPA polycarbonate resin made by the interfacial | GE Advanced |
| (PC-5) (PC125) | process with an MVR at 300° C./1.2 kg, of 19.5-22.6 g/ | Materials |
| | 10 min | |
| Poly(ethylene | Poly(ethylene terephthalate with an IV of 0.78-0.84 dl/g | Eastman |
| terephthalate) | (grade: Eastapak 9921W) | Chemical BV |
| (PET) | | |
| MBS 1 | MBS is nominal 75-82 wt. % butadiene core | Rohm & Haas |
| | with a balance styrene-methyl methacrylate | |
| | shell. Trade name EXL-2691A | |
| MBS 2 | MBS is nominal 76-80 wt. % butadiene core | Rohm & Haas |
| | with a balance styrene-methyl methacrylate | |
| | shell. Trade name EXL-2650A | |
| HRG 29170 | High rubber graft emulsion polymerized ABS | GE Advanced |
| | comprising 15-35 wt. % acrylonitrile and 85-65 wt. % | Materials |
| | styrene grafted on to a core of 85-100 wt. % | |
| | butadiene and with a 15-0 wt. % styrene. | |
| | The core represents about 25-75% of the total | |
| | emulsion ABS. The materials are crosslinked to | |
| | a density of 43-55% as measured by sol-gel | |
| | fraction. | |
| Filler 1 | Talc (Trade name Jetfine 3CA) | Luzenac |
| Filler 2 | Talc (Trade name Talc 9102) | Barretts/ |
| | | Specialty |
| | | Minerals |
| Filler 3 | Ultratalc 609 (Trade name Microtuff AG 609) | Keyser & |
| | | Mackay/ |
| | | Specialty |
| | | Minerals |
| Filler 4 | Mica (Trade name Aspanger Mica SFG 20) | Internatio BV |
| Filler 5 | Glass Fiber (Trade name OCF 105B-12P) | Owens Corning |
| T-SAN | PTFE (polytetrafluoroethylene) encapsulated in | GE Advanced |
| | SAN (50% fluoropolymer) | Materials |
| Acid 1 | Phosphorous Acid (H₃PO₃) 45% acid in water | Quaron |
| Acid 2 | Phosphoric Acid (H₃PO₄) 10% acid diluted in | Epenhuysen |
| | water | |
| Acid 3 | Mono Zinc Phosphate (Trade name Z21-82) | CFB |
| | | Budenheim |
| Acid 4 | Mono Calcium Phosphate (Trade name HT | Ulrich |
| | Monocalcium Phosphate, Monol Spray Dried- | Chemical |
| | Fines) | |
| Acid 5 | Sodium Acid Pyrophosphate (Trade name | CFB |
| | SAPP) | Budenheim |
| SAN | Styrene acrylonitrile copolymer comprising 15-35 wt. % | GE Advanced |
| | acrylonitrile with an Melt Flow of 5.2-7.2 g/ | Materials |
| | 10 min. | |

Each of five sample compositions was prepared according to amounts in Table 2. All amounts are in weight percent. Sample 1 is a control sample with no filler and no acid; sample 2 is a control sample with filler and no acid; and samples 3 to 5 are examples of the invention with different acid amounts. The molecular weight and melt flow rate were measured and are shown in Table 2. In each of the examples, samples were prepared by melt extrusion on a Werner & Pfleider™ 25 mm twin screw extruder at a nominal melt temperature of about 300° C. (572° F.), about 0.7 bars of mercury vacuum, and about 300 rpm. The extrudate was pelletized and dried at about 120° C. (248° F.) for about 2 hours. To make test specimens, the dried pellets were injection molded on an 110-ton injection molding machine at a nominal melt temperature of 310° C., wherein the barrel temperature of the injection molding machine varied from about 310° C. to about 325° C. The previously described processing conditions are referred to herein as the high temperature profile for “pure” polycarbonate blends (without impact modifiers and the like).

TABLE 2
Talc Filled Polycarbonate

| Component/ | | | | | |
|---|---|---|---|---|---|
| Test | Sample 1 | Sample 2 | Sample 3 | Sample 4 | Sample 5 |
| PC-1 | 100.0 | 80.0 | 80.0 | 80.0 | 80.0 |
| Stabilizer | 0.1 | 0.1 | 0.1 | 0.1 | 0.1 |
| Filler 1 | 0 | 20.0 | 20.0 | 20.0 | 20.0 |
| Acid 1 | 0 | 0 | 0.3 | 0.6 | 1.2 |
| MVR | 28.0 | 129.3 | 37.8 | 31.3 | 27.1 |
| 300° C. | | | | | |
| 2.16 kg | | | | | |
| PC Mw | 41100 | 27900 | 26900 | 39100 | 39100 |

As seen from Table 2, sample 2, which contained talc but no acid experienced a significant increase in MVR and a decrease in molecular weight, thereby showing that the polycarbonate degrades with the addition of the filler. Samples 3 to 5 all had molecular weights much better than Sample 2 and closer to that of Sample 1 with no talc, showing much less degradation.

Additional samples were produced using the materials in Table 1. Additionally, 0.85 wt. % additives were added to each sample, as known to one skilled in the art. The additive package included a mold release agent and primary and secondary antioxidants. In each of these examples, samples were prepared by melt extrusion on a Werner & Pfleider™ 25 mm twin screw extruder at nominal melt temperature of about 280° C. (536° F.), about 0.7 bars of mercury vacuum, and about 450 rpm. The extrudate was pelletized and dried at about 100° C. (212° F.) for about 2 hours. To make test specimens, the dried pellets were injection molded on an 110-ton injection molding machine at a nominal melt temperature of 280° C. (536° F.), wherein the barrel temperature of the injection molding machine varied from about 280° C. to about 295° C. (536° F. to 563° F.). The previously described processing conditions are referred to herein as the low temperature profile for impact modified polycarbonate blends. The formulations are shown in Table 3, and the results are shown in Table 4. All amounts in Table 3 are weight percent unless otherwise specified.

TABLE 3
Talc Filled Polycarbonate/SAN/MBS Blends

| Component | Sample 6 | Sample 7 | Sample 8 | Sample 9 |
|---|---|---|---|---|
| PC-2 | 77.250 | 77.010 | 76.770 | 76.290 |
| Additives | 0.85 | 0.85 | 0.85 | 0.85 |
| SAN | 9.500 | 9.500 | 9.500 | 9.500 |
| MBS 1 | 4.400 | 4.400 | 4.400 | 4.400 |
| Filler 1 | 8.000 | 8.000 | 8.000 | 8.000 |
| Acid 1 | 0 | 0.240 | 0.480 | 0.960 |

The compositions of Table 3 were tested for polycarbonate Molecular Weight, Melt Volume Rate, Charpy Notched Impact Strength, Flexural Modulus, Heat Deflection Temperature, Izod Notched Impact Strength, Melt Viscosity and Vicat B/50. The details of these tests and other tests (such as Tensile and Flex Plate Impact properties) used in the examples are known to those of ordinary skill in the art, and may be summarized as follows:

Charpy Notched Impact ISO 179 is used to compare the impact resistances of plastic materials. Charpy Notched Impact was determined using a 4 mm thick, molded impact bar. The ISO results are defined as the impact energy in joules used to break the test specimen, divided by the specimen area at the notch. Results are reported in kJ/m².

Molecular Weight is measured by gel permeation chromatography (GPC) in methylene chloride solvent. Polystyrene calibration standards are used to determine and report relative molecular weights (values reported are polycarbonate molecular weight relative to polystyrene, not absolute polycarbonate molecular weight numbers). Changes in weight average molecular weight are typically used. This provides a means of measuring changes in chain length of a polymeric material, which can be used to determine the extent of degradation of the thermoplastic as a result of exposure processing. Degraded materials would generally show reduced molecular weight, and could exhibit reduced physical properties. Typically, molecular weights are determined before and after processing, then a percentage difference is calculated.

Melt Volume Rate (MVR) was determined at 300° C. using a 2.16-kilogram weight, over 10 minutes for the samples in Table 2, and at 260° C. using a 5-kilogram weight, over 10 minutes for the samples in Table 3, in accordance with ISO 1133.

Izod Impact Strength ISO 180 (‘NiH’) is used to compare the impact resistances of plastic materials. Izod Impact was determined using a 4 mm thick, molded Izod notched impact (INI) bar. It was determined per ISO 180/1A. The ISO designation reflects type of specimen and type of notch: ISO 180/1A means specimen type 1 and notch type A. ISO 180/1U means the same type 1 specimen, but clamped in a reversed way, (indicating unnotched). The ISO results are defined as the impact energy in joules used to break the test specimen, divided by the specimen area at the notch. Results are reported in kJ/m².

Flexural Modulus was determined using a 4 mm-thick INI bar, pursuant to ISO 178.

Heat Deflection Temperature (HDT) is a relative measure of a material's ability to perform for a short time at elevated temperatures while supporting a load. The test measures the effect of temperature on stiffness: a standard test specimen is given a defined surface stress and the temperature is raised at a uniform rate. Heat Deflection Test (HDT) was determined per ISO 75Af, using a flat, 4 mm thick bar, molded Tensile bar subjected to 1.8 Mpa and/or 0.45 Mpa, as indicated. Although not mentioned in the test standard, two acronyms are commonly used: HDT/A for a load of 1.80 Mpa, and HDT/B for a load of 0.45 Mpa

Vicat Softening Temperature (ISO 306) is a measure of the temperature at which a plastic starts to soften rapidly. A round, flat-ended needle of 1 mm² cross section penetrates the surface of a plastic test specimen under a predefined load, and the temperature is raised at a uniform rate. The Vicat softening temperature, or VST, is the temperature at which the penetration reaches 1 mm. ISO 306 describes two methods: Method A—load of 10 Newtons (N), and Method B—load of 50 N, with two possible rates of temperature rise: 50° C./hour (° C./h) or 120° C./h. This results in ISO values quoted as A/50, A/120, B/50 or B/120. The test assembly is immersed in a heating bath with a starting temperature of 23° C. After 5 minutes (min) the load is applied: 10 N or 50 N. The temperature of the bath at which the indenting tip has penetrated by 1±0.01 mm is reported as the VST of the material at the chosen load and temperature rise.

Melt Viscosity (MV) is a measure of a polymer at a given temperature at which the molecular chains can move relative to each other. Melt viscosity is dependent on the molecular weight, in that the higher the molecular weight, the greater the entanglements and the greater the melt viscosity. Melt viscosity can therefore be used to determine the extent of degradation of the thermoplastic. Degraded materials would generally show decreased viscosity, and could exhibit reduced physical properties. Melt viscosity is determined against different shear rates such as 100; 500; 1,000; 1,500; 5,000; and 10,000s⁻¹, and may be conveniently determined by ISO 11443.

Tensile properties such as Tensile Strength and Tensile Elongation to break were determined using 4 mm thick molded tensile bars tested per ISO 527 at 5 mm/min. It is also possible to measure at 50 mm/min. if desired for the specific application, but the samples measured in the experiments in Tables 5 to 10 were measured at 5 mm/min., and those in Tables 12 and 13 were measured at 50 mm/min. Tensile modulus is always measured at the start of the test with an initial rate of 1 mm/min, after which the test is continued at either 5 mm/min. or 50 mm/min. to measure the other tensile properties.

Flex Plate Impact is determined per ISO 6603 and in the described experiments with an impact speed of 2.25 m/s. Reported values are the FPI % ductility and the Puncture Energy. FPI % Ductility (at a certain temperature, such as 0 or 20° C.) is reported as the percentage of five samples which, upon failure in the impact test, exhibited a ductile failure rather than rigid failure, the latter being characterized by cracking and the formation of shards. The Puncture Energy is a measure of the absorbed energy capacity of the material at given temperature.

The results of the tests on samples 6 to 9 are set forth in Table 4 below.

TABLE 4

| Test | Sample 6 | Sample 7 | Sample 8 | Sample 9 |
|---|---|---|---|---|
| PC Mw | 55900 | 62400 | 61600 | 60800 |
| MVR 260° C., 5 kg | 10.5 | 5.9 | 6.3 | 7.4 |
| (cm³/10 min) | | | | |
| Charpy Notched Impact | 13.5 | 77.3 | 68.2 | 48.3 |
| RT (kJ/m²) | | | | |
| Flexural Modulus (Mpa) | 3030 | 3030 | 2985 | 3015 |
| HDT 1.8 MPa flat (° C.) | 118.9 | 121.5 | 121.3 | 121.5 |
| Izod Notched Impact RT | 10.9 | 63.1 | 47.5 | 40.1 |
| (kJ/m²) | | | | |
| Vicat B/50 (° C.) | 138.4 | 140.7 | 139.4 | 140.0 |

Table 4 illustrates that the Notched Impact properties (both Charpy and Izod) are improved when phosphorous acid (Acid 1) is added to the filled blends. The combination of the acid and filler effectively prevents or reduces the amount of polycarbonate degradation.

Additional samples were prepared in the same manner as previously described using the materials of Table 1 to compare various filler types, acid types, and acid levels. The formulations and the results are shown in Tables 5 to 11 below.

There are two sets of operating conditions for extrusion and molding. The “pure” polycarbonate blends (such as those in Table 2, which do not have impact modifiers or vinyl aromatic copolymers) are produced using high temperature profile described for the samples in Table 2. The impact modified polycarbonate blends are produced using lower temperature profile, as described for the samples in Tables 3 and4.

TABLE 5

| | | SAMPLE | | | | | | | | | | |
|---|---|---|---|---|---|---|---|---|---|---|---|---|
| | Units | 10 | 11 | 12 | 13 | 14 | 15 | 16 | 17 | 18 | 19 | 20 |
| COMPONENTS* | | | | | | | | | | | | |
| PC-3 | % | 77.25 | 77.22 | 77.19 | 77.13 | 77.01 | 76.77 | 76.29 | 75.33 | 85.22 | 85.01 | 83.33 |
| SAN | % | 9.50 | 9.50 | 9.50 | 9.50 | 9.50 | 9.50 | 9.50 | 9.50 | 9.50 | 9.50 | 9.50 |
| MBS 1 | % | 4.40 | 4.40 | 4.40 | 4.40 | 4.40 | 4.40 | 4.40 | 4.40 | 4.40 | 4.40 | 4.40 |
| Filler 1 | % | 8.00 | 8.00 | 8.00 | 8.00 | 8.00 | 8.00 | 8.00 | 8.00 | 0 | 0 | 0 |
| Acid 1 | % | 0 | 0.03 | 0.06 | 0.12 | 0.24 | 0.48 | 0.96 | 1.92 | 0.03 | 0.24 | 1.92 |
| PHYSICAL PROPERTIES | | | | | | | | | | | | |
| MVR 260° C. 5 kg | cm³/10 min | 13.2 | 10.2 | 9.2 | 8.7 | 8.8 | 9.4 | 10.6 | 12.2 | 11.3 | 16.0 | 39.4 |
| Izod Notched | KJ/m² | 9.7 | 12.9 | 32.0 | 39.6 | 43.4 | 38.7 | 34.0 | 8.6 | 64.1 | 43.7 | 6.2** |
| Impact, 23° C. | | | | | | | | | | | | |
| FPI Ductility, −20° C. | % | 0 | 60 | 100 | 100 | 100 | 100 | 100 | 0 | 100 | 0 | 0 |
| FPI Puncture | J | 90 | 86 | 93 | 108 | 122 | 122 | 116 | 75 | 94 | 41 | 1 |
| Energy, −20° C. | | | | | | | | | | | | |
| Tensile Modulus | MPa | 3157 | 3204 | 3208 | 3198 | 3174 | 3118 | 3170 | 3224 | 2340 | 2370 | 2892 |
| Tensile Strength | MPa | 60 | 60 | 60 | 59 | 58 | 59 | 59 | 60 | 58 | 59 | 47 |
| Tensile Elongation | % | 112 | 124 | 128 | 128 | 117 | 116 | 125 | 105 | 135 | 104 | 4 |
| Vicat B/50 | ° C. | 137 | 138 | 138 | 139 | 138 | 138 | 138 | 137 | 138 | 135 | 126 |
| PC Mw Retention: | | | | | | | | | | | | |
| Virgin PC | % | 100 | 100 | 100 | 100 | 100 | 100 | 100 | 100 | 100 | 100 | 100 |
| Compounding | % | 93 | 99 | 100 | 100 | 100 | 100 | 100 | 97 | 100 | 97 | 86 |
| Molding | % | 84 | 92 | 95 | 98 | 98 | 98 | 97 | 89 | 97 | 71 | 53 |

*A stabilization package, as described above, was used in an amount of 0.85% in each sample.
**Value is Unnotched Izod Impact since the sample was too brittle to notch.

TABLE 6

| | | SAMPLE | | | | | | |
|---|---|---|---|---|---|---|---|---|
| | Units | 21 | 22 | 23 | 24 | 25 | 26 | 27 |
| COMPONENTS* | | | | | | | | |
| PC-2 | % | 99.9 | 99.3 | 89.9 | 89.3 | 87.2 | 89.3 | 89.3 |
| Filler 1 | % | 0 | 0 | 10.0 | 10.0 | 10.0 | 10.0 | 10.0 |
| Acid 1 | % | 0 | 0.60 | 0 | 0.60 | 0 | 0 | 0 |
| Acid 2 | % | 0 | 0 | 0 | 0 | 2.70 | 0 | 0 |
| Acid 3 | % | 0 | 0 | 0 | 0 | 0 | 0.60 | 0 |
| Acid 4 | % | 0 | 0 | 0 | 0 | 0 | 0 | 0.60 |
| PHYSICAL PROPERTIES | | | | | | | | |
| MVR 300° C. 2.16 kg | cm³/10 min | 9.3 | 34.4 | 280 | 9.7 | 11.8 | 11.5 | 12.4 |
| Izod Notched Impact, 23° C. | KJ/m² | 15.2 | 8.7 | 5.3 | 8.6 | 7.2 | 8.1 | 7.4 |
| FPI Ductility, −20° C. | % | 100 | 20 | 0 | 100 | 100 | 100 | 100 |
| FPI Puncture Energy, −20° C. | J | 160 | 16 | 10 | 124 | 111 | 116 | 100 |
| Tensile Modulus | MPa | 2247 | 2272 | 3310 | 3077 | 3181 | 3270 | 3266 |
| Tensile Strength | MPa | 61 | 62 | 69 | 64 | 65 | 66 | 66 |
| Tensile Elongation | % | 121 | 62 | 11 | 108 | 45 | 79 | 107 |
| Vicat B/50 | ° C. | 149 | 143 | 133 | 147 | 146 | 145 | 144 |
| PC Mw Retention: | | | | | | | | |
| Virgin PC | % | 100 | 100 | 100 | 100 | 100 | 100 | 100 |
| Compounding | % | 100 | 86 | 73 | 98 | 98 | 97 | 95 |
| Molding | % | 100 | 72 | 60 | 92 | 87 | 91 | 91 |

*A stabilization package, as described above, was used in an amount of 0.10% in each sample.

TABLE 7

| | | SAMPLE | | | | | | | | | | | |
|---|---|---|---|---|---|---|---|---|---|---|---|---|---|
| | Units | 21 | 22 | 23 | 24 | 28 | 29 | 30 | 31 | 32 | 33 | 34 | 35 |
| COMPONENTS* | | | | | | | | | | | | | |
| PC-2 | % | 99.9 | 99.3 | 89.9 | 89.3 | 89.9 | 89.3 | 89.9 | 89.3 | 89.9 | 89.3 | 89.9 | 89.3 |
| Acid 1 | % | 0 | 0.60 | 0 | 0.60 | 0 | 0.60 | 0 | 0.60 | 0 | 0.60 | 0 | 0.60 |
| Filler 1 | % | 0 | 0 | 10.0 | 10.0 | 0 | 0 | 0 | 0 | 0 | 0 | 0 | 0 |
| Filler 2 | % | 0 | 0 | 0 | 0 | 10.0 | 10.0 | 0 | 0 | 0 | 0 | 0 | 0 |
| Filler 3 | % | 0 | 0 | 0 | 0 | 0 | 0 | 10.0 | 10.0 | 0 | 0 | 0 | 0 |
| Filler 4 | % | 0 | 0 | 0 | 0 | 0 | 0 | 0 | 0 | 10.0 | 10.0 | 0 | 0 |
| Filler 5 | % | 0 | 0 | 0 | 0 | 0 | 0 | 0 | 0 | 0 | 0 | 10.0 | 10.0 |
| PHYSICAL | | | | | | | | | | | | | |
| PROPERTIES | | | | | | | | | | | | | |
| MVR 300° C. | cm³/10 min | 9.3 | 34.4 | 280 | 9.7 | 270 | 8.6 | 260 | 8.9 | 23.8 | 10.0 | 6.6 | 20.5 |
| 2.16 kg | | | | | | | | | | | | | |
| Izod Notched | KJ/m² | 15.2 | 8.7 | 5.3 | 8.6 | 5.3 | 9.0 | 4.7 | 7.9 | 5.7 | 6.5 | 9.2 | 7.6 |
| Impact, 23° C. | | | | | | | | | | | | | |
| FPI Ductility, | % | 100 | 20 | 0 | 100 | 0 | 100 | 0 | 100 | 60 | 100 | 100 | 100 |
| −20° C. | | | | | | | | | | | | | |
| FPI Puncture | J | 160 | 16 | 10 | 124 | 10 | 117 | 9 | 125 | 106 | 119 | 88 | 66 |
| Energy, −20° C. | | | | | | | | | | | | | |
| Tensile Modulus | MPa | 2247 | 2272 | 3310 | 3077 | 3406 | 2948 | 3379 | 2974 | 3051 | 2865 | 3178 | 2591 |
| Tensile Strength | MPa | 61 | 62 | 69 | 64 | 67 | 62 | 67 | 63 | 66 | 63 | 70 | 55 |
| Tensile Elongation | % | 121 | 62 | 11 | 108 | 9 | 114 | 7 | 110 | 81 | 100 | 6 | 9 |
| Vicat B/50 | ° C. | 149 | 143 | 133 | 147 | 134 | 147 | 133 | 147 | 142 | 147 | 151 | 145 |
| PC Mw Retention: | | | | | | | | | | | | | |
| Virgin PC | % | 100 | 100 | 100 | 100 | 100 | 100 | 100 | 100 | 100 | 100 | 100 | 100 |
| Compounding | % | 100 | 86 | 73 | 98 | 75 | 99 | 68 | 100 | 87 | 100 | 100 | 89 |
| Molding | % | 100 | 72 | 60 | 92 | 61 | 95 | 51 | 91 | 75 | 92 | 100 | 68 |

*A stabilization package, as described above, was used in an amount of 0.10% in each sample.

TABLE 8

| | | SAMPLE | | | | | | | | | |
|---|---|---|---|---|---|---|---|---|---|---|---|
| | Units | 36 | 37 | 38 | 39 | 40 | 41 | 42 | 43 | 44 | 45 |
| COMPONENTS* | | | | | | | | | | | |
| PC-3 | % | 85.25 | 83.25 | 77.25 | 71.25 | 65.25 | 83.19 | 77.01 | 70.83 | 64.65 | 85.01 |
| SAN | % | 9.50 | 9.50 | 9.50 | 9.50 | 9.50 | 9.50 | 9.50 | 9.50 | 9.50 | 9.50 |
| MBS 1 | % | 4.40 | 4.40 | 4.40 | 4.40 | 4.40 | 4.40 | 4.40 | 4.40 | 4.40 | 4.40 |
| Filler 1 | % | 0 | 2.00 | 8.00 | 14.00 | 20.00 | 2.00 | 8.00 | 14.00 | 20.00 | 0 |
| Acid 1 | % | 0 | 0 | 0 | 0 | 0 | 0.06 | 0.24 | 0.42 | 0.60 | 0.24 |
| PHYSICAL | | | | | | | | | | | |
| PROPERTIES | | | | | | | | | | | |
| MVR 260° C. 5 kg | cm³/10 min | 11.4 | 12.1 | 13.2 | 16.6 | 19.2 | 11.0 | 8.8 | 7.9 | 5.5 | 16.0 |
| Izod Notched | KJ/m² | 62.7 | 52.5 | 9.7 | 5.8 | 3.6 | 60.8 | 43.4 | 19.51 | 8.39 | 43.7 |
| Impact, 23° C. | | | | | | | | | | | |
| FPI Ductility, | % | 100 | 100 | 0 | 0 | 0 | 100 | 100 | 80 | 0 | 0 |
| −20° C. | | | | | | | | | | | |
| FPI Puncture | J | 99 | 93 | 90 | 56 | 1 | 95 | 122 | 86 | 22 | 41 |
| Energy, −20° C. | | | | | | | | | | | |
| Tensile Modulus | MPa | 2318 | 2543 | 3175 | 3935 | 4831 | 2524 | 3174 | 3885 | 4735 | 2370 |
| Tensile Strength | MPa | 57 | 59 | 60 | 62 | 65 | 58 | 58 | 60 | 62 | 59 |
| Tensile Elongation | % | 141 | 125 | 112 | 7 | 3 | 115 | 117 | 75 | 6 | 104 |
| Vicat B/50 | ° C. | 139 | 137 | 137 | 135 | 132 | 138 | 138 | 138 | 137 | 135 |
| PC Mw Retention: | | | | | | | | | | | |
| Virgin PC | % | 100 | 100 | 100 | 100 | 100 | 100 | 100 | 100 | 100 | 100 |
| Compounding | % | 100 | 99 | 93 | 92 | 85 | 100 | 100 | 100 | 99 | 97 |
| Molding | % | 96 | 93 | 84 | 71 | 59 | 96 | 98 | 96 | 97 | 71 |

*A stabilization package, as described above, was used in an amount of 0.85% in each sample.

TABLE 9

| | | SAMPLE | | | | | |
|---|---|---|---|---|---|---|---|
| | Units | 46 | 47 | 48 | 49 | 50 | 51 |
| COMPONENTS* | | | | | | | |
| PC-4 | % | 73.800 | 73.800 | 73.617 | 73.617 | 73.434 | 73.434 |
| SAN | % | 4.79 | 4.79 | 4.79 | 4.79 | 4.79 | 4.79 |
| HRG 29170 | % | 4.36 | 4.36 | 4.36 | 4.36 | 4.36 | 4.36 |
| Filler 2 | % | 12.2 | 0 | 12.2 | 0 | 12.2 | 0 |
| Filler 1 | % | 0 | 12.2 | 0 | 12.2 | 0 | 12.2 |
| TSAN | % | 4.0 | 4.0 | 4.0 | 4.0 | 4.0 | 4.0 |
| Acid 1 | % | 0 | 0 | 0.183 | 0.183 | 0.366 | 0.366 |
| Acid/Filler Weight Ratio | | 0.000 | 0.000 | 0.015 | 0.015 | 0.030 | 0.030 |
| PHYSICAL PROPERTIES | | | | | | | |
| Apparent Viscosity MV 300° C. at | Pa · s | 135 | 128 | 147 | 142 | 138 | 141 |
| 5000 s−1 | | | | | | | |
| Izod Notched Impact, 23° C. | KJ/m² | 14.5 | 15.8 | 15.7 | 18.3 | 15.6 | 18.7 |
| FPI Ductility, 0° C. | % | 100 | 100 | 100 | 100 | 100 | 100 |
| FPI Ductility, −20° C. | % | 0 | 0 | 0 | 0 | 0 | 0 |
| Tensile Modulus | MPa | 3889 | 4083 | 3828 | 4019 | 3777 | 3993 |
| Tensile Strength | MPa | 61 | 63 | 62 | 63 | 62 | 63 |
| Tensile Elongation | % | 44 | 43 | 89 | 82 | 90 | 79 |
| Vicat B/50 | ° C. | 136 | 136 | 137 | 137 | 137 | 137 |
| PC Mw Retention: | | | | | | | |
| Virgin PC | % | 100 | 100 | 100 | 100 | 100 | 100 |
| Compounding | % | 98 | 99 | 99 | 99 | 100 | 98 |
| Molding | % | 91 | 89 | 97 | 95 | 95 | 97 |

*A stabilization package, as described above, was used in an amount of 0.85% in each sample.

TABLE 10

| | | SAMPLE | | | | | |
|---|---|---|---|---|---|---|---|
| | Units | 52 | 53 | 54 | 55 | 56 | 57 |
| COMPONENTS* | | | | | | | |
| PC-4 | % | 70.775 | 70.550 | 67.730 | 67.460 | 72.775 | 72.550 |
| SAN | % | 4.79 | 4.79 | 4.79 | 4.79 | 4.79 | 4.79 |
| HRG 29170 | % | 4.36 | 4.36 | 4.36 | 4.36 | 4.36 | 4.36 |
| Filler 1 | % | 15.0 | 15.0 | 18.0 | 18.0 | 15.0 | 15.0 |
| TSAN | % | 4.0 | 4.0 | 4.0 | 4.0 | 2.0 | 2.0 |
| Acid 1 | % | 0.225 | 0.450 | 0.270 | 0.540 | 0.225 | 0.450 |
| Acid/Filler Weight | | 0.015 | 0.030 | 0.015 | 0.030 | 0.015 | 0.030 |
| Ratio | | | | | | | |
| PHYSICAL | | | | | | | |
| PROPERTIES | | | | | | | |
| Apparent Viscosity | Pa · s | 139 | 139 | 139 | 138 | 114 | 115 |
| MV 300° C. | | | | | | | |
| 5000 s−1 | | | | | | | |
| Izod Notched | KJ/m² | 15.6 | 15.0 | 12.5 | 12.9 | 20.3 | 18.6 |
| Impact, 23° C. | | | | | | | |
| FPI Ductility, 0° C. | % | 100 | 100 | 80 | 100 | 100 | 100 |
| FPI Ductility, | % | 0 | 0 | 0 | 0 | 20 | 0 |
| −20° C. | | | | | | | |
| Tensile Modulus | MPa | 4486 | 4389 | 4915 | 4840 | 4270 | 4242 |
| Tensile Strength | MPa | 64 | 64 | 65 | 65 | 63 | 63 |
| Tensile Elongation | % | 15 | 17 | 11 | 12 | 18 | 23 |
| Vicat B/50 | ° C. | 137 | 137 | 137 | 137 | 138 | 139 |
| PC Mw Retention: | | | | | | | |
| Virgin PC | % | 100 | 100 | 100 | 100 | 100 | 100 |
| Compounding | % | 99 | 96 | 99 | 99 | 100 | 99 |
| Molding | % | 95 | 96 | 93 | 96 | 93 | 96 |
| | | SAMPLE | | | | | |
| | Units | 58 | 59 | 60 | 61 | 62 | 63 |
| COMPONENTS* | | | | | | | |
| PC-4 | % | 74.775 | 74.550 | 69.730 | 69.460 | 71.730 | 71.460 |
| SAN | % | 4.79 | 4.79 | 4.79 | 4.79 | 4.79 | 4.79 |
| HRG 29170 | % | 4.36 | 4.36 | 4.36 | 4.36 | 4.36 | 4.36 |
| Filler 1 | % | 15.0 | 15.0 | 18.0 | 18.0 | 18.0 | 18.0 |
| TSAN | % | 0 | 0 | 2.0 | 2.0 | 0 | 0 |
| Acid 1 | % | 0.225 | 0.450 | 0.270 | 0.540 | 0.270 | 0.540 |
| Acid/Filler Weight | | 0.015 | 0.030 | 0.015 | 0.030 | 0.015 | 0.030 |
| Ratio | | | | | | | |
| PHYSICAL | | | | | | | |
| PROPERTIES | | | | | | | |
| Apparent Viscosity | Pa · s | 104 | 106 | 116 | 112 | 105 | 105 |
| MV 300° C. | | | | | | | |
| 5000 s−1 | | | | | | | |
| Izod Notched | KJ/m² | 12.6 | 13.0 | 15.5 | 15.9 | 10.0 | 10.7 |
| Impact, 23° C. | | | | | | | |
| FPI Ductility, 0° C. | % | 100 | 100 | 100 | 100 | 100 | 100 |
| FPI Ductility, | % | 20 | 40 | 0 | 0 | 0 | 0 |
| −20° C. | | | | | | | |
| Tensile Modulus | MPa | 4092 | 4066 | 4588 | 4633 | 4600 | 4442 |
| Tensile Strength | MPa | 62 | 62 | 63 | 64 | 63 | 63 |
| Tensile Elongation | % | 66 | 70 | 16 | 12 | 8 | 8 |
| Vicat B/50 | ° C. | 141 | 141 | 139 | 138 | 140 | 141 |
| PC Mw Retention: | | | | | | | |
| Virgin PC | % | 100 | 100 | 100 | 100 | 100 | 100 |
| Compounding | % | 100 | 100 | 100 | 99 | 100 | 100 |
| Molding | % | 93 | 98 | 94 | 96 | 96 | 98 |

*A stabilization package, as described above, was used in an amount of 0.85% in each sample.

TABLE 11

| | Units | Sample 64 | Sample 65 |
|---|---|---|---|
| Component | | | |
| PC*** | % | 77.25 | 77.01 |
| PC Ratio*** | | 25:75 | 75:25 |
| SAN | % | 9.500 | 9.500 |
| MBS 1 | % | 4.400 | 4.400 |
| Filler 1 | % | 8.000 | 8.000 |
| Acid 1 | % | 0 | 0.240 |
| Additives | % | 0.85 | 0.85 |
| Physical Properties | | | |
| MVR 260° C. 5 kg | cm³/10 min | 13.2 | 21.2 |
| Apparent Viscosity MV | Pa · s | 281 | 241 |
| 260° C. 5000 s−1 | | | |
| Izod Notched Impact, 23° C. | KJ/m² | 9.7 | 11.8 |
| Vicat B/50 | ° C. | 137 | 137 |
| Virgin PC MW | | 56000 | 46000 |
| PC MW Molded Sample | | 46800 | 45500 |
| PC MW Retention | % | 84 | 99 |

***PC is a blend of PC-1 and PC-2 in the above ratio of % PC-1 to % PC-2.

Table 5 illustrates that the samples with no filler but different levels of acid have more degradation of the polycarbonate blend than those with the filler. Compare samples 11, 14 and 17 with samples 18, 19 and 20. Samples 11, 14 and 17 have 8% talc and acid levels of 0.03, 0.24 and 1.92% acid respectively, while samples 18, 19 and 20 have the same acid levels but no filler added. FPI ductility at −20° C. significantly improved by the addition of a very small amount (about 0.03%) of acid, and an acid to filler weight ratio of only 0.00375. Optimal results providing polycarbonate blends having the best balance of properties were achieved at higher acid levels of about 0.06 to about 0.96% acid at an acid to filler weight ratio of about 0.0075 to about 0.12.

Table 6 illustrates the effects of different acids and shows that some acids have a greater effect than others on the filled polycarbonate, although all of the acids used in this example, when added to a filled polycarbonate, were effective and resulted in a good balance of properties and molecular weight retention.

Table 7 compares the effects of an acid (such as phosphorous acid, Acid 1) with different fillers and shows that the acid has little improvement effect on glass filled polycarbonate. The results of this table also confirm that acid in most cases significantly improves the performance of a mineral filled polycarbonate.

Table 8 compares samples with varying levels of talc with and without acid added. Samples 37 to 40 have filler levels from 2 to 20% with no acid, and samples 41 to 44 have the same filler and filler levels with increasing acid levels from 0.06 to 0.6%, with the acid to filler weight ratio remaining constant at 0.03 to 1. Additionally, comparing sample 38, which has filler but no acid, to sample 45, which has acid but no filler, show that without the combination of filler and acid, the polycarbonate blend is degraded. As shown in Tables 6 and 7, sample 22 clearly shows the effect of the addition of acid on filled polycarbonate blends as the acid induces degradation of the polycarbonate. Surprisingly, though, the addition of acid to a mineral filled polycarbonate or polycarbonate blend significantly improves the mineral filled polycarbonate or polycarbonate blend, even with a very high acid levels (see, for example, Table 5).

Tables 8 and 9 compare two filler types at varying acid levels, comparing each filler at two different acid to filler ratios, as well as at different TSAN levels. Filler 1 (Jetfine 3CA) showed better performance when used with acid than Filler 2 (Talc 9102). Additionally, blends that had TSAN as an additional component do not show the same improvement level as those without TSAN. Samples 58 to 63 showed a good blend of physical properties such as flow, impact and stiffness (ductility).

The polycarbonate molecular weight (PC Mw) of samples 64 and 65 was measured before and after processing (extrusion and molding). Table 11 compares the PC Mw of samples 64 and 65. Sample 64 had no acid to the blend. The polycarbonate molecular weight (PC Mw) of sample 64 was measured to be 56000 initially and 46800 after extrusion and molding, while for sample 65 the PC Mw was measured to be 46000 initially and 45500 after extrusion and molding. Sample 65 showed slightly less than 100% PC Mw retention, while sample 64, which had no acid, had only about 84% retention of Mw. Although sample 64 started with a high PC Mw, the PC Mw of the molded sample decreased due to degradation and is comparable to that of sample 65, which had very little degradation, after extrusion and molding. Sample 65 has superior impact and better flow (lower viscosity) than sample 64 clearly demonstrating the effect of the acid addition resulting in excellent impact/flow balance. In addition to the excellent balance of properties, the molecular weight retention (or lack of polycarbonate degradation provides the necessary process stability for customers to prevent defects such as splay or negative properties.

Additional samples were prepared using the materials of Table 1 to compare various acid types and acid levels in polycarbonate/poly(ethylene terephthalate) (PC/PET) blends. The samples were prepared in the same manner as previously described except that the materials were compounded at 270° C. and molded at approximately 275° C., with the melt temperature approximately 5 to 10° C. higher. The formulations and the results are shown in Tables 12 and 13 below.

TABLE 12

| | | SAMPLE | | | | | | | |
|---|---|---|---|---|---|---|---|---|---|
| | Units | 66 | 67 | 68 | 69 | 70 | 71 | 72 | 73 |
| COMPONENTS* | | | | | | | | | |
| PC-2 | % | 34.6 | 34.5 | 34.4 | 34.2 | 33.9 | 41.55 | 41.47 | 41.23 |
| PC-5 | % | 10.0 | 10.0 | 10.0 | 10.0 | 10.0 | 12.00 | 12.00 | 12.00 |
| PET | % | 30.0 | 30.0 | 30.0 | 30.0 | 30.0 | 36.00 | 36.00 | 36.00 |
| MBS 2 | % | 10.0 | 10.0 | 10.0 | 10.0 | 10.0 | 10.00 | 10.00 | 10.00 |
| Filler 1 | % | 15.0 | 15.0 | 15.0 | 15.0 | 15.0 | 0 | 0 | 0 |
| Acid 1 | % | 0 | 0.08 | 0.16 | 0.32 | 0.64 | 0 | 0.08 | 0.32 |
| Acid/Filler Weight Ratio | | 0 | .0053 | .0106 | .0213 | .0426 | 0 | 0 | 0 |
| PHYSICAL | | | | | | | | | |
| PROPERTIES | | | | | | | | | |
| MVR 280° C. 5 kg | cm³/10 min | 8.0 | 14.8 | 19.0 | 24.3 | 30.5 | 16.3 | 40.4 | 104.8 |
| Izod Notched Impact, | KJ/m² | 21.1 | 13.5 | 12.3 | 10.7 | 8.5 | 53.1 | 52.4 | 4.9 |
| 23° C. | | | | | | | | | |
| Tensile Modulus | MPa | 3706 | 3714 | 3716 | 3660 | 3608 | 2065 | 2084 | 2161 |
| Tensile Strength | MPa | 60 | 61 | 61 | 61 | 61 | 53 | 54 | 56 |
| Tensile Elongation | % | 19 | 15 | 17 | 15 | 15 | 181 | 154 | 53 |

*A stabilization package, as described above, was used in an amount of 0.45% in each sample.

TABLE 13

| | | SAMPLE | | | | | | | | | | |
|---|---|---|---|---|---|---|---|---|---|---|---|---|
| | Units | 74 | 75 | 76 | 77 | 78 | 79 | 80 | 81 | 82 | 83 | 84 |
| COMPONENTS* | | | | | | | | | | | | |
| PC-2 | % | 34.6 | 34.4 | 33.8 | 33.0 | 41.35 | 39.95 | 34.4 | 33.8 | 33.0 | 41.35 | 39.95 |
| PC-5 | % | 10.0 | 10.0 | 10.0 | 10.0 | 12.0 | 12.0 | 10.0 | 10.0 | 10.0 | 12.0 | 120. |
| PET | % | 30.0 | 30.0 | 30.0 | 30.0 | 36.0 | 36.0 | 30.0 | 30.0 | 30.0 | 36.0 | 36.0 |
| MBS 2 | % | 10.0 | 10.0 | 10.0 | 10.0 | 10.0 | 10.0 | 10.0 | 10.0 | 10.0 | 10.0 | 10.0 |
| Filler 1 | % | 15.0 | 15.0 | 15.0 | 15.0 | 0 | 0 | 15.0 | 15.0 | 15.0 | 0 | 0 |
| Acid 2 | % | 0 | 0.2 | 0.8 | 1.6 | 0.2 | 1.6 | 0 | 0 | 0 | 0 | 0 |
| Acid 5 | % | 0 | 0 | 0 | 0 | 0 | 0 | 0.2 | 0.8 | 1.6 | 0.2 | 1.6 |
| Acid/Filler Weight | | 0 | .0133 | .0533 | .1067 | 0 | 0 | .0133 | .0533 | .1067 | 0 | 0 |
| Ratio | | | | | | | | | | | | |
| PHYSICAL | | | | | | | | | | | | |
| PROPERTIES | | | | | | | | | | | | |
| MVR 280° C. 5 kg | cm³/ | 8.3 | 30.1 | 59.3 | 78.4 | 35.6 | 162.4 | 11.9 | 15.2 | 19.2 | 19.0 | 20.6 |
| | 10 min | | | | | | | | | | | |
| Izod Notched | KJ/m² | 32.5 | 7.5 | 2.8 | 2.9 | 65.2 | 4.6 | 19.1 | 13.0 | 7.3 | 53.4 | 38.8 |
| Impact, 23° C. | | | | | | | | | | | | |
| Tensile Modulus | MPa | 3611 | 3700 | 3749 | 3804 | 2030 | 2138 | 3698 | 3733 | 3777 | 2004 | 2037 |
| Tensile Strength | MPa | 59 | 62 | 61 | 57 | 53 | 56 | 61 | 61 | 61 | 53 | 53 |
| Tensile Elongation | % | 65 | 12 | 3 | 2 | 161 | 28 | 23 | 16 | 11 | 156 | 142 |

*A stabilization package, as described above, was used in an amount of 0.45% in each sample.

The addition of various acids and acid salts to filled and unfilled polycarbonate/poly(ethylene terephthalate) blends degraded the PC/PET blend. The PC/PET blends experienced showing a decrease in properties such as impact, and an increase in MVR upon acid addition. These examples show that the addition of acid to certain types of polycarbonate blends, such as PC/PET blends, in relatively large amounts (that is, greater than necessary for quenching and stabilization of the polycarbonate or polycarbonate blend) does not always result in a balance of properties such as impact and flow. Even at a fairly low level of acid addition (0.08% for an acid/filler weight ratio of 0.0053), the PC/PET blend properties start to decrease more than is desirable.

The singular forms “a,” “an,” and “the” include plural referents unless the context clearly dictates otherwise. The endpoints of all ranges reciting the same characteristic are combinable and inclusive of the recited endpoints. All references are incorporated herein by reference. Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group. The modifier “about” used in connection with a quantity is inclusive of the stated value and has the meaning dictated by the context (e.g., includes the degree of error associated with measurement of the particular quantity).

While typical embodiments have been set forth for the purpose of illustration, the foregoing descriptions should not be deemed to be a limitation on the scope herein. Accordingly, various modifications, adaptations, and alternatives may occur to one skilled in the art without departing from the spirit and scope herein.

What is claimed is:

1. A thermoplastic composition, comprising:
a polycarbonate resin;
a mineral filler; and
an acid or acid salt;
wherein the acid or acid salt is present in the composition in a weight ratio of acid to filler of at least 0.0035:1.

2. The composition of claim 1, wherein the acid is an inorganic acid or inorganic acid salt.

3. The composition of claim 1, wherein the mineral filler is selected from the group consisting of talc, clay, mica, wollastonite, and combinations thereof.

4. The composition of claim 1, further comprising an aromatic vinyl copolymer.

5. The composition of claim 4 wherein the aromatic vinyl copolymer comprises SAN.

6. The composition of claim 1, further comprising an impact modifier.

7. The composition of claim 6 wherein the impact modifier is selected from the group consisting of ABS, MBS, Bulk ABS, AES, ASA, MABS, and combinations thereof.

8. The composition of claim 1, wherein the acid or acid salt is present in the composition in a weight ratio of acid to filler of at least 0.005:1.

9. The composition of claim 1, wherein the acid or acid salt is present in the composition in a weight ratio of acid to filler of at least 0.0075:1.

10. An article comprising the composition of claim 1.

11. A method for forming an article, comprising molding, extruding, shaping or forming the composition of claim 1 to form the article.

12. A thermoplastic composition, comprising:
a polycarbonate resin;
a mineral filler; and
an inorganic acid or inorganic acid salt;
wherein the acid or acid salt is present in the composition in a weight ratio of acid to filler of greater than 0.0035:1.

13. The thermoplastic composition of claim 12, further comprising an impact modifier.

14. The composition of claim 12, wherein the acid or acid salt is present in the composition in a weight ratio of acid to filler of at least 0.005:1.

15. The composition of claim 12, wherein the acid or acid salt is present in the composition in a weight ratio of acid to filler of at least 0.0075:1.

16. A thermoplastic composition, comprising:
a polycarbonate resin;
an impact modifier;
a mineral filler; and
an acid or acid salt;
wherein the acid or acid salt is present in the composition in a ratio of acid to filler of greater than 0.0035:1.

17. The thermoplastic composition of claim 16, further comprising an aromatic vinyl copolymer.

18. The composition of claim 16, wherein the acid is an inorganic acid or inorganic acid salt.

19. The composition of claim 16, wherein the mineral filler is selected from the group consisting of talc, clay, mica, wollastonite, and combinations thereof.

20. The composition of claim 16, wherein the acid or acid salt is present in the composition in a weight ratio of acid to filler of at least 0.005:1.

21. The composition of claim 16, wherein the acid or acid salt is present in the composition in a weight ratio of acid to filler of at least 0.0075:1.
